(19) United States
(12) Patent Application Publication
(10) Pub. No.: US 2022/0384908 A1
(43) Pub. Date: Dec. 1, 2022

(54) THERMALLY STABLE POLYMER COMPOSITE SEPARATOR FOR A LITHIUM SECONDARY BATTERY AND MANUFACTURING METHOD

(71) Applicant: Global Graphene Group, Inc., Dayton, OH (US)

(72) Inventor: Bor Z. Jang, Centerville, OH (US)

(21) Appl. No.: 17/314,569

(22) Filed: May 7, 2021

(51) Int. Cl. H01M 50/446; H01M 10/052; H01M 50/403; H01M 50/414; H01M 50/434; H01M 50/497; H01M 10/0525

(52) U.S. Cl. CPC H01M 50/446; H01M 10/052; H01M 50/403; H01M 50/414; H01M 50/434; H01M 50/497; H01M 10/0525; H01M 2300/0068

(57) ABSTRACT

A lithium secondary battery comprising a cathode, an anode, and a thermally stable polymer composite separator disposed between said cathode and said anode, wherein said composite separator comprises a thermally stable polymer, comprising a phosphorous-containing polymer, and from 30% to 99% by weight of particles of an inorganic material electrolyte and the particles are dispersed in or bonded by the thermally stable polymer, wherein the composite separator has a thickness from 50 nm to 100 μm and a lithium ion conductivity from 10⁻⁸ S/cm to 5×10⁻² S/cm at room temperature.

### FIELD

The present disclosure relates to the field of rechargeable lithium battery, including the lithium-ion battery and lithium metal battery, and, in particular, to an anode-less rechargeable lithium metal battery having no lithium metal as an anode active material initially when the battery is made and a method of manufacturing same.

### BACKGROUND

Lithium-ion and lithium (Li) metal cells (including Lithium-sulfur cell, Li-air cell, etc.) are considered promising power sources for electric vehicle (EV), hybrid electric vehicle (HEV), and portable electronic devices, such as lap-top computers and mobile phones. Lithium metal has the highest capacity (3,861 mAh/g) compared to any other metal or metal-intercalated compound (except Li_{4.4}Si) as an anode active material. Hence, in general, rechargeable Li metal batteries have a significantly higher energy density than lithium-ion batteries.

Historically, rechargeable lithium metal batteries were produced using non-lithiated compounds having high specific capacities, such as TiS₂, MoS₂, MnO₂, CoO₂ and V₂O₅, as the cathode active materials, which were coupled with a lithium metal anode. When the battery was discharged, lithium ions were dissolved from the lithium metal anode and transferred to the cathode through the electrolyte and, thus, the cathode became lithiated. Unfortunately, upon cycling, the lithium metal resulted in the formation of dendrites that ultimately caused unsafe conditions in the battery. As a result, the production of these types of secondary batteries was stopped in the early 1990's giving ways to lithium-ion batteries.

Even now, cycling stability and safety concerns remain the primary factors preventing the further commercialization of Li metal batteries for EV, HEV, and microelectronic device applications. These issues are primarily due to the high tendency for Li to form dendrite structures during repeated charge-discharge cycles or an overcharge, leading to internal electrical shorting and thermal runaway. Many attempts have been made to address the dendrite-related issues, as briefly summarized below:

Fauteux, et al. [D. Fauteux, et al., “Secondary Electrolytic Cell and Electrolytic Process,” U.S. Pat. No. 5,434,021, Jul. 18, 1995] applied to a metal anode a protective surface layer (e.g., a mixture of polynuclear aromatic and polyethylene oxide) that enables transfer of metal ions from the metal anode to the electrolyte and back. The surface layer is also electronically conductive so that the ions will be uniformly attracted back onto the metal anode during electrodeposition (i.e. during battery recharge). Alamgir, et al. [M. Alamgir, et al. “Solid polymer electrolyte batteries containing metallocenes,” U.S. Pat. No. 5,536,599, Jul. 16, 1996] used ferrocenes to prevent chemical overcharge and dendrite formation in a solid polymer electrolyte-based rechargeable battery.

Skotheim [T. A. Skotheim, “Stabilized Anode for Lithium-Polymer Battery,” U.S. Pat. No. 5,648,187 (Jul. 15, 1997); U.S. Pat. No. 5,961,672 (Oct. 5, 1999)] provided a Li metal anode that was stabilized against the dendrite formation by the use of a vacuum-evaporated thin film of a Li ion-conducting polymer interposed between the Li metal anode and the electrolyte. Skotheim, et al. [T. A. Skotheim, et al. “Lithium Anodes for Electrochemical Cells,” U.S. Pat. No. 6,733,924 (May 11, 2004); U.S. Pat. No. 6,797,428 (Sep. 28, 2004); U.S. Pat. No. 6,936,381 (Aug. 30, 2005); and No. 7,247,408 (Jul. 24, 2007)] further proposed a multilayer anode structure consisting of a Li metal-based first layer, a second layer of a temporary protective metal (e.g., Cu, Mg, and Al), and a third layer that is composed of at least one layer (typically 2 or more layers) of a single ion-conducting glass, such as lithium silicate and lithium phosphate, or polymer. It is clear that such an anode structure, consisting of at least 3 or 4 layers, is too complex and too costly to make and use.

Protective coatings for Li anodes, such as glassy surface layers of LiI— Li₃PO₄—P₂S₅, may be obtained from plasma assisted deposition [S. J. Visco, et al., “Protective Coatings for Negative Electrodes,” U.S. Pat. No. 6,025,094 (Feb. 15, 2000)]. Complex, multi-layer protective coatings were also proposed by Visco, et al. [S. J. Visco, et al., “Protected Active Metal Electrode and Battery Cell Structures with Non-aqueous Interlayer Architecture,” U.S. Pat. No. 7,282,295 (Oct. 16, 2007); U.S. Pat. No. 7,282,296 (Oct. 16, 2007); and No. 7,282,302 (Oct. 16, 2007)].

Despite these earlier efforts, no rechargeable Li metal batteries have yet succeeded in the market place. This is likely due to the notion that these prior art approaches still have major deficiencies. For instance, in several cases, the anode or electrolyte structures are too complex. In others, the materials are too costly or the processes for making these materials are too laborious or difficult. Conventional solid electrolytes typically have a low lithium ion conductivity, are difficult to produce and difficult to implement into a battery.

Furthermore, the conventional solid electrolyte, as the sole electrolyte in a cell or as an anode-protecting layer (interposed between the lithium film and another electrolyte) does not have and cannot maintain a good contact with the lithium metal. This reduces the effectiveness of the electrolyte to support dissolution of lithium ions (during battery discharge), transport lithium ions, and allowing the lithium ions to re-deposit back to the lithium anode (during battery recharge). A ceramic separator that is disposed between an anode active material layer (e.g. a graphite-based anode layer or a lithium metal layer) and a cathode active layer suffers from the same problems as well. In addition, a ceramic separator also has a poor contact with the cathode layer if the electrolyte in the cathode layer is a solid electrolyte (e.g., inorganic solid electrolyte).

Another major issue associated with the lithium metal anode is the continuing reactions between liquid electrolyte and lithium metal, leading to repeated formation of “dead lithium-containing species” that cannot be re-deposited back to the anode and become isolated from the anode. These reactions continue to irreversibly consume electrolyte and lithium metal, resulting in rapid capacity decay. In order to compensate for this continuing loss of lithium metal, an excessive amount of lithium metal (3-5 times higher amount than what would be required) is typically implemented at the anode when the battery is made. This adds not only costs but also a significant weight and volume to a battery, reducing the energy density of the battery cell. This important issue has been largely ignored and there has been no plausible solution to this problem in battery industry.

Clearly, an urgent need exists for a simpler, more cost-effective, and easier to implement approach to preventing Li metal dendrite-induced internal short circuit and thermal runaway problems in Li metal batteries, and to reducing or eliminating the detrimental reactions between lithium metal and the electrolyte.

Hence, an object of the present disclosure was to provide an effective way to overcome the lithium metal dendrite and reaction problems in all types of Li metal batteries having a lithium metal anode. A specific object of the present disclosure was to provide a lithium cell (either lithium-ion cell or lithium metal cell) that exhibits a high specific capacity, high specific energy, high degree of safety, and a long and stable cycle life.

### SUMMARY

The present disclosure provides a lithium secondary battery comprising a cathode, an anode, and a thermally stable polymer composite separator (ion-conducting membrane) disposed between the cathode and the anode, wherein the composite separator comprises a thermally stable polymer, comprising a phosphorous-containing polymer, and from 30% to 99% (preferably >60%, more preferably >70%, and further preferably >80% by weight) of particles of an inorganic material and the particles are dispersed in or bonded by the thermally stable polymer, wherein the composite separator has a thickness from 50 nm to 100 μm (preferably from 1 to 20 μm and more preferably thinner than 10 μm) and a lithium ion conductivity from 10⁻⁸ S/cm to 5×10⁻² S/cm when measured at room temperature.

In certain preferred embodiments, the phosphorous-containing polymer is selected from polyphosphazene, polyphosphate, polyphosphonate, polyphosphinate, polyphosphine, polyphosphine oxide, poly(phosphonic acid), polymerized phosphorous acid, polymerized phosphite, poly(phosphoric acid), or a combination thereof.

Polyphosphazenes, also commonly referred to as poly(organo)phosphazenes, are a family of inorganic molecular hybrid polymers based on a phosphorus—nitrogen backbone substituted with organic side groups which show a broad array of unique properties due to the vast array of organic substituents possible.

In certain embodiments, the polymer in a thermally stable polymer composite separator may comprise a polyvinyl phosphonate polymer comprising chains derived from a phosphonate vinyl monomer. The polymer refers to a phosphorus-containing polymer functionalized at the side chain (herein referred to as a polyvinyl phosphonate), instead of that at the main chain or backbone chain (e.g., polyphosphazene having P in the main chain). The polyvinyl phosphonate herein also includes polyvinylphosphonic acid and its various copolymers. The phosphonate vinyl monomer also includes the vinylphosphonic acid monomer.

The phosphonate vinyl monomer may include allyl-type, vinyl-type, styrenic-type and (meth)acrylic-type monomers bearing phosphonate groups (i.e., either mono or bisphosphonate). In certain embodiments, the phosphonate vinyl monomer is selected from the group consisting of phosphonate bearing allyl monomers (e.g., Dialkyl allylphosphonate monomers and Dioxaphosphorinane allyl monomers), phosphonate bearing vinyl monomers (e.g., Dialkyl vinyl phosphonate monomers and Dialkyl vinyl ether phosphonate monomers), phosphonate bearing styrenic monomers (e.g., α-, (β-, and p-vinylbenzyl phosphonate monomers), phosphonate bearing (meth)acrylic monomers (e.g., phosphonate groups linked to the acrylate double bond, phosphonate groups linked to the ester, and phosphonate groups linked to the amide), vinylphosphonic acids, and combinations thereof. Examples of Phosphonate bearing (meth)acrylic monomers include α-(dialkylphosphonate) acrylate, β-(dialkylphosphonate) acrylate, dialkylphosphonate (meth)acrylate, and N-(dialkylphosphonate) (meth)acrylamide.

In certain embodiments, the anode in the lithium secondary battery has an amount of lithium or lithium alloy as an anode active material supported by an anode current collector. In certain other embodiments, initially the anode has no lithium or lithium alloy as an anode active material supported by the anode current collector when the battery is made and prior to a charge or discharge operation of the battery. This latter configuration is referred to as an anode-less lithium battery. During the first battery charge operation, lithium ions come out of the cathode active material, move to the anode, and deposit onto a surface of the anode current collector.

In certain embodiments, the battery is a lithium-ion battery and the anode has an anode current collector and a layer of an anode active material supported by the anode current collector, wherein the anode active materials is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles (g) prelithiated versions thereof; and (h) combinations thereof.

The anode current collector may be selected from, for instance, a Cu foil, a Cu-coated polymer film, a sheet of Ni foam, a porous layer of nano-filaments, such as graphene sheets, carbon nanofibers, carbon nano-tubes, etc.

Preferably, the inorganic material comprises an inorganic solid electrolyte material (dispersed in the thermally stable polymer composite separator layer) is in a fine powder form having a particle size preferably from 10 nm to 30 μm, more preferably from 50 nm to 1 μm. The inorganic solid electrolyte material may be selected from an oxide type, sulfide type, hydride type, halide type, borate type, phosphate type, lithium phosphorus oxynitride (LiPON), Garnet-type, lithium superionic conductor (LISICON), sodium superionic conductor (NASICON), or a combination thereof. These solid electrolyte particles can improve the lithium ion transport rates of the composite separator.

In some embodiments, the inorganic material particles comprise a material selected from a transition metal oxide (e.g., TiO₂), aluminum oxide, silicon dioxide, transition metal sulfide, transition metal selenide, alkylated ceramic particles, metal phosphate, metal carbonate, or a combination thereof. These particles act to stop the penetration of any potential lithium dendrite that otherwise could cause internal shorting.

The thermally stable polymer may further comprise from 0.1% to 50% by weight of a lithium ion-conducting additive, which is different from the inorganic solid electrolyte particles.

In some embodiments, this thermally stable polymer composite layer may be a thin film disposed against a surface of an anode current collector. The anode contains a current collector without a lithium metal or any other anode active material, such as graphite or Si particles, when the battery cell is manufactured. Such a battery cell having an initially lithium metal-free anode is commonly referred to as an “anode-less” lithium battery. The lithium ions that are required for shuttling back and forth between the anode and the cathode are initially stored in the cathode active materials (e.g. Li in LiMn₂O₄ and LiMPO₄, where M=Ni, Co, F, Mn, etc.). During the first battery charge procedure, lithium ions (Li⁺) come out of the cathode active material, move through the electrolyte and then through the presently disclosed protective high-elasticity polymer layer and get deposited on a surface of the anode current collector. As this charging procedure continues, more lithium ions get deposited onto the current collector surface, eventually forming a lithium metal film or coating.

In certain embodiments, the thermally stable polymer further contains a reinforcement material dispersed therein wherein the reinforcement material is selected from a polymer fiber, a glass fiber, a ceramic fiber or nano-flake (e.g., nano clay flakes), or a combination thereof. The reinforcement material preferably has a thickness or diameter less than 100 nm.

The thermally stable polymer composite may further comprise a lithium salt (as a lithium ion-conducting additive) dispersed in the polymer wherein the lithium salt may be preferably selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethylsulfonylimide (LiBETI), lithium bis(trifluoromethanesulphonyl)imide, lithium bis(fluorosulphonyl)imide, lithium trifluoromethanesulfonimide (LiTFSI), an ionic liquid-based lithium salt, or a combination thereof.

The working electrolyte in the lithium battery may be selected from an organic liquid electrolyte, ionic liquid electrolyte, polymer gel electrolyte, solid polymer electrolyte, inorganic solid-state electrolyte, quasi-solid electrolyte having a lithium salt dissolved in an organic or ionic liquid with a lithium salt concentration higher than 2.0 M, or a combination thereof. At the anode side, preferably and typically, the thermally stable polymer composite for the protective layer has a lithium ion conductivity no less than 10⁻⁵ S/cm, more preferably no less than 10⁻⁴ S/cm, and most preferably no less than 10⁻³ S/cm.

In some embodiments, the thermally stable polymer composite further comprises a lithium ion-conducting additive dispersed in a polymer matrix material, wherein the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0≤x≤1, 1≤y≤4.

In some embodiments, the high-elasticity polymer forms a mixture, blend, or semi-interpenetrating network (semi-IPN) with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof. Sulfonation is herein found to impart improved lithium ion conductivity to a polymer.

The cathode active material may be selected from an inorganic material, an organic material, a polymeric material, or a combination thereof. The inorganic material may be selected from a metal oxide, metal phosphate, metal silicide, metal selenide (e.g. lithium polyselides for use in a Li—Se cell), metal sulfide (e.g. lithium polysulfide for use in a Li—S cell), or a combination thereof. Preferably, these cathode active materials contain lithium in their structures; otherwise the cathode should contain a lithium source.

The inorganic cathode active material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The cathode active material layer may contain a metal oxide containing vanadium oxide selected from the group consisting of LiₓVO₂, LiₓV₂O₅, LiₓV₃O₈, LiₓV₃O₇, LiₓV₄O₉, LiₓV₆O₁₃, their doped versions, their derivatives, and combinations thereof, wherein 0.1<x<5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The cathode active material is preferably in a form of nano particle (spherical, ellipsoidal, and irregular shape), nano wire, nano fiber, nano tube, nano sheet, nano belt, nano ribbon, nano disc, nano platelet, or nano horn having a thickness or diameter less than 100 nm. These shapes can be collectively referred to as “particles” unless otherwise specified or unless a specific type among the above species is desired. Further preferably, the cathode active material has a dimension less than 50 nm, even more preferably less than 20 nm, and most preferably less than 10 nm. In some embodiments, one particle or a cluster of particles may be coated with or embraced by a layer of carbon disposed between the particle(s) and/or a high-elasticity polymer layer (an encapsulating shell).

The cathode layer may further contain a graphite, graphene, or carbon material mixed with the cathode active material particles. The carbon or graphite material is selected from polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, or a combination thereof. Graphene may be selected from pristine graphene, graphene oxide, reduced graphene oxide, graphene fluoride, hydrogenated graphene, nitrogenated graphene, functionalized graphene, etc.

The cathode active material particles may be coated with or embraced by a conductive protective coating, which is selected from a carbon material, graphene, electronically conductive polymer, conductive metal oxide, or conductive metal coating.

In certain embodiments, the polymer composite separator layer has two primary surfaces with a first primary surface facing the anode side and a second primary surface opposing or opposite to the first primary surface and wherein the inorganic material particles (e.g., inorganic solid electrolyte powder) has a first concentration at the first surface and a second concentration at the second surface and the first concentration is greater than the second concentration. In other words, there are more inorganic particles at the anode side of the polymer composite layer than the opposite side intended to be facing the cathode. There is a concentration gradient across the thickness of the elastic composite separator layer. The high concentration of inorganic solid particles on the anode side (preferably >30% by weight and more preferably >60% by weight) can help stop the penetration of any lithium dendrite, if formed, and help to form a stable artificial solid-electrolyte interphase (SEI). Thus, in some embodiments, the composite separator has a gradient concentration of the inorganic solid particles across the thickness of the separator.

The disclosure also provides a polymer composite separator for use in a lithium battery. The separator comprises (i) a thermally stable polymer, comprising a phosphorous-containing polymer, and (ii) from 30% to 99% by weight of particles of an inorganic material wherein the particles are dispersed in or bonded by the thermally stable polymer and wherein the composite separator has a thickness from 50 nm to 100 μm and a lithium ion conductivity from 10⁻⁸ S/cm to 5×10⁻² S/cm at room temperature.

The phosphorous-containing polymer is preferably selected from polyphosphazene, polyphosphate, polyphosphonate, polypliosphinate, polyphosphine, polyphosphine oxide, poly(phosphonic acid), polymerized phosphorous acid, polymerized phosphite, poly(phosphoric acid), or a combination thereof.

The inorganic material may comprise particles of an inorganic solid electrolyte material selected from an oxide type, sulfide type, hydride type, halide type, borate type, phosphate type, lithium phosphorus oxynitride (UPON), Garnet-type, lithium superionic conductor (LISICON) type, sodium superionic conductor (NAS ICON) type, or a combination thereof.

In some embodiments, the inorganic material particles comprise a material selected from a transition metal oxide, aluminum oxide, silicon dioxide, transition metal sulfide, transition metal selenide, alkylated ceramic particles, metal phosphate, metal carbonate, or a combination thereof.

The thermally stable polymer may further comprise from 0.1% to 30% by weight of a lithium ion-conducting additive, which is different from the inorganic solid electrolyte particles in composition or structure. The lithium ion-conducting additive may comprise a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof. This lithium ion-conducting additive is dispersed in the matrix of the thermally stable polymer.

In some embodiments, the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0≤x≤1, 1≤y≤4.

Preferably, the thermally stable polymer forms a mixture, blend, copolymer, or interpenetrating network with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

The disclosure also provides a process for manufacturing a thermally stable polymer composite separator, the process comprising (A) dispersing particles of an inorganic solid material in a liquid reactive mass of a polymer precursor to a thermally stable polymer to form a slurry; (B) dispensing and depositing a layer of the liquid reactive mass onto a solid substrate surface; and (C) polymerizing and/or crosslinking the polymer precursor in the reactive mass to form a layer of the polymer composite separator. This polymer precursor may comprise a monomer, an oligomer, or an uncured (but curable) polymer possibly dissolved in a liquid solvent where necessary. This precursor is subsequently cured (polymerized and/or crosslinked).

This solid substrate can be a glass surface, a polymer film surface, a metal foil surface, etc. in order to form a free-standing film for a polymer composite separator. In certain preferred embodiments, the solid substrate may be an anode current collector, an anode active material layer, or a cathode active material layer. In other words, this polymer composite separator can be directly deposited onto a layer of anode active material, an anode current collector, or a layer of cathode active material. This is achievable because curing of the polymer does not require a high temperature; curing temperature being typically lower than 300° C. or even lower than 100° C. This is in stark contrast to the typically 900-1,200° C. required of sintering an inorganic solid electrolyte to form a ceramic separator. In addition, the presently disclosed polymer composite separator is at least as good as a ceramic separator in terms of reducing interfacial impedance and stopping dendrite penetration.

Preferably, the process is a roll-to-roll process wherein step (B) comprises (i) continuously feeding a layer of the solid substrate (e.g. flexible metal film, plastic film, etc.) from a feeder roller to a dispensing zone where the reactive mass is dispensed and deposited onto the solid substrate to form a continuous layer of the reactive mass; (ii) moving the layer of the reactive mass into a reacting zone where the reactive mass is exposed to heat, ultraviolet (UV) light, or high-energy radiation to polymerize and/or cure the reactive mass to form a continuous layer of polymer composite; and (iii) collecting the polymer composite on a winding roller. This process is conducted in a reel-to-reel manner.

The process may further comprise cutting and trimming the layer of polymer composite into one or multiple pieces of composite separators.

The process may further comprise combining an anode, the polymer composite separator, an electrolyte, and a cathode electrode to form a lithium battery.

If desirable, the resulting elastic composite separator may be soaked in or impregnated with an organic or ionic liquid electrolyte.

### BRIEF DESCRIPTION OF THE DRAWINGS

FIG. 1 Schematic of a prior art lithium metal battery cell, containing an anode layer (a thin Li foil or Li coating deposited on a surface of a current collector, Cu foil), a porous separator, and a cathode active material layer, which is composed of particles of a cathode active material, a conductive additive (not shown) and a resin binder (not shown). A cathode current collector supporting the cathode active layer is also shown.

FIG. 2 Schematic of a presently disclosed lithium metal battery cell (upper diagram) containing an anode current collector (e.g., Cu foil) but no anode active material (when the cell is manufactured or in a fully discharged state), a polymer composite separator, and a cathode active material layer, which is composed of particles of a cathode active material, a conductive additive (not shown) and a resin binder (not shown). A cathode current collector supporting the cathode active layer is also shown. The lower diagram shows a thin lithium metal layer deposited between the Cu foil and the composite separator layer when the battery is in a charged state.

FIG. 3(A) Schematic of a polymer elastic composite separator layer wherein the inorganic solid electrolyte particles are uniformly dispersed in a matrix of a thermally stable polymer according to some embodiments of the present disclosure;

FIG. 3(B) Schematic of a polymer composite separator layer wherein the inorganic solid electrolyte particles are preferentially dispersed near one surface (e.g., facing the anode side) of a polymer composite separator layer; the opposing surface has a lower or zero concentration of the inorganic solid electrolyte particles, according to some embodiments of the present disclosure.

FIG. 3(C) Schematic of a polymer composite separator layer wherein the inorganic solid electrolyte particles are preferentially dispersed at the core of a polymer composite separator layer; the outer regions have a lower or zero concentration of the inorganic solid electrolyte particles, according to some embodiments of the present disclosure.

FIG. 4 Schematic of a roll-to-roll process for producing rolls of elastic composite separator in a continuous manner.

### DETAILED DESCRIPTION

This disclosure is related to a lithium secondary battery, which is preferably based on a working electrolyte selected from an organic electrolyte, a polymer gel electrolyte, a solid polymer electrolyte, an ionic liquid electrolyte, a quasi-solid electrolyte, or an inorganic solid-state electrolyte in the anode and/or the cathode. The anode and the cathode are separated by a solid-state polymer composite separator. The shape of a lithium secondary battery can be cylindrical, square, button-like, etc. The present disclosure is not limited to any battery shape or configuration or any type of electrolyte.

The present disclosure provides a lithium secondary battery comprising a cathode, an anode, and a thermally stable polymer composite separator (ion-conducting membrane) disposed between the cathode and the anode, wherein the composite separator comprises a thermally stable polymer, comprising a phosphorous-containing polymer, and from 30% to 99% (preferably >60%, more preferably >70%, and further preferably >80% by weight) of particles of an inorganic material and the particles are dispersed in or bonded by the thermally stable polymer, wherein the composite separator has a thickness from 50 nm to 100 μm (preferably from 1 to 20 μm) and a lithium ion conductivity from 10⁻⁸ S/cm to 5×10⁻² S/cm when measured at room temperature. In a typical configuration, the separator is in ionic contact with both the anode and the cathode and typically in physical contact with an anode active material layer (or an anode current collector) and with a cathode active material layer.

The phosphorous-containing polymer is preferably selected from polyphosphazene, polyphosphate, polyphosphonate, polyphosphinate, polyphosphine, polyphosphine oxide, poly(phosphonic acid), polymerized phosphorous acid, polymerized phosphite, poly(phosphoric acid), or a combination thereof.

Preferably, the thermally stable polymer forms a mixture, blend, copolymer, or interpenetrating network with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof. Mixing, co-polymerizing or semi-IPN formation methods are well-known in the art. For instance, one can simply dissolve the two polymers and/or their monomers in a common solvent, following by solvent removal to form a polymer blend. Chemical reaction between chains can be activated while these polymers/monomers are in a solution state or a solid mixed state.

The inorganic material may comprise particles of an inorganic solid electrolyte material selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof.

In some embodiments, the inorganic material particles comprise a material selected from a transition metal oxide, aluminum oxide, silicon dioxide, transition metal sulfide, transition metal selenide, alkylated ceramic particles, metal phosphate, metal carbonate, or a combination thereof.

In certain embodiments, the anode in the lithium secondary battery has an amount of lithium or lithium alloy as an anode active material supported by an anode current collector. In certain other embodiments, initially the anode has no lithium or lithium alloy as an anode active material supported by an anode current collector when the battery is made and prior to a charge or discharge operation of the battery. This latter configuration is referred to as an anode-less lithium battery. The current collector may be a Cu foil, a layer of Ni foam, a porous layer of nano-filaments, such as graphene sheets, carbon nanofibers, carbon nano-tubes, etc. forming a 3D interconnected network of electron-conducting pathways.

Preferably, this polymer composite separator layer is different in composition than the working electrolyte used in the lithium battery and the polymer composite layer maintains as a discrete layer (not to be dissolved in the working electrolyte).

We have discovered that this composite ceramic layer provides several unexpected benefits: (a) the formation and penetration of dendrite can be essentially eliminated; (b) uniform deposition of lithium back to the anode side is readily achieved during battery charging; (c) the layer ensures smooth and uninterrupted transport of lithium ions from/to the anode current collector surface (or the lithium film deposited thereon during the battery operations) and through the interface between the current collector (or the lithium film deposited thereon) and the polymer composite separator layer with minimal interfacial resistance; and (d) cycle stability can be significantly improved and cycle life increased. No additional protective layer for the lithium metal anode is required. The separator itself also plays the role as an anode protective layer.

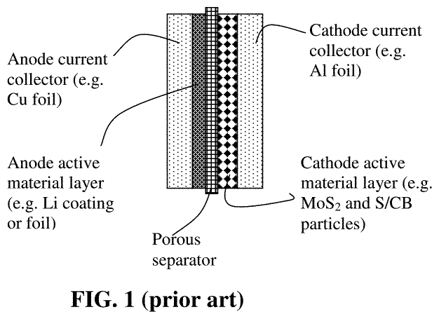

In a conventional lithium metal cell, as illustrated in FIG. 1, the anode active material (lithium) is deposited in a thin film form or a thin foil form directly onto an anode current collector (e.g., a Cu foil) before this anode and a cathode are combined to form a cell. The battery is a lithium metal battery, lithium sulfur battery, lithium-selenium battery, etc. As previously discussed in the Background section, these lithium secondary batteries have the dendrite-induced internal shorting and “dead lithium” issues at the anode.

We have solved these challenging issues that have troubled battery designers and electrochemists alike for more than 30 years by developing and implementing a new polymer composite separator disposed between the anode (an anode current collector or an anode active material layer) and a cathode active material layer. This polymer composite separator layer has a lithium ion conductivity no less than 10⁻⁸ S/cm at room temperature (preferably and more typically from 1×10⁻⁵ S/cm to 5×10⁻² S/cm).

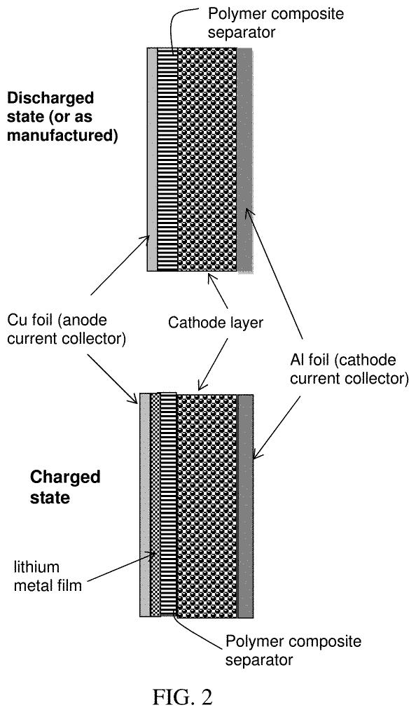

As schematically shown in FIG. 2, one embodiment of the present disclosure is a lithium metal battery cell containing an anode current collector (e.g., Cu foil), an anode-protecting layer, a polymer composite-based separator, and a cathode active material layer. The cathode active material layer is composed of particles of a cathode active material, a conductive additive (not shown) and a resin binder (not shown). A cathode current collector (e.g., Al foil) supporting the cathode active layer is also shown in FIG. 2.

It may be noted that FIG. 2 shows a lithium battery that initially does not contain a lithium foil or lithium coating at the anode (only an anode current collector, such as a Cu foil or a graphene/CNT mat) when the battery is made. The needed lithium to be bounced back and forth between the anode and the cathode is initially stored in the cathode active material (e.g., lithium vanadium oxide LiₓV₂O₅, instead of vanadium oxide, V₂O₅; or lithium polysulfide, instead of sulfur). During the first charging procedure of the lithium battery (e.g., as part of the electrochemical formation process), lithium comes out of the cathode active material, passes through the elastic composite separator and deposits on the anode current collector. The presence of the presently disclosed polymer composite separator (in good contact with the current collector) enables the uniform deposition of lithium ions on the anode current collector surface. Such a battery configuration avoids the need to have a layer of lithium foil or coating being present during battery fabrication. Bare lithium metal is highly sensitive to air moisture and oxygen and, thus, is more challenging to handle in a real battery manufacturing environment. This strategy of pre-storing lithium in the lithiated (lithium-containing) cathode active materials, such as LiₓV₂O₅ and Li₂Sₓ, makes all the materials safe to handle in a real manufacturing environment. Cathode active materials, such as LiₓV₂O₅ and Li₂Sₓ, are typically not air-sensitive.

As the charging procedure continues, more lithium ions get to deposit onto the anode current collector, forming a lithium metal film or coating. During the subsequent discharge procedure, this lithium film or coating layer decreases in thickness due to dissolution of lithium into the electrolyte to become lithium ions, creating a gap between the current collector and the protective layer if the separator layer were not elastic. Such a gap would make the re-deposition of lithium ions back to the anode impossible during a subsequent recharge procedure. We have observed that a selected polymer composite separator layer is capable of expanding or shrinking congruently or conformably with the anode layer. This capability helps to maintain a good contact between the current collector (or the lithium film subsequently or initially deposited on the current collector surface) and the protective layer, enabling the re-deposition of lithium ions without interruption.

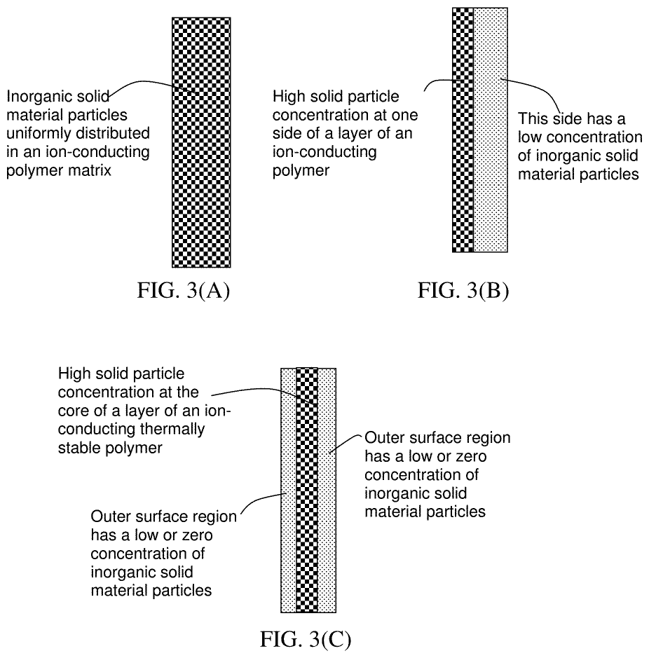

In certain embodiments, inorganic material particles are non-uniformly distributed in the thermally stable polymer matrix in such a manner that a concentration of the inorganic material particles in one region of the polymer matrix is greater than a concentration of the inorganic material particles in another region. For instance, FIG. 3(A) schematically shows a polymer composite separator layer wherein inorganic solid material particles are uniformly dispersed in a matrix of an elastic polymer according to some embodiments of the present disclosure.

According to some other embodiments of the present disclosure, FIG. 3(B) schematically shows a polymer composite separator layer wherein inorganic solid electrolyte particles are preferentially dispersed near one surface (e.g., facing the anode side) of an elastic composite separator layer; the opposing surface has a lower or zero concentration of the inorganic solid electrolyte particles. This latter structure has the advantages that the high-concentration portion, being strong and rigid, provides a lithium dendrite-stopping capability while other portion of the layer remains highly elastic to maintain good contacts with neighboring layers (e.g., cathode active material layer containing a solid electrolyte on one side and lithium metal on the other) for reduced interfacial impedance.

FIG. 3(C) schematically shows a polymer composite separator layer wherein the inorganic solid electrolyte particles are disposed at the core of a polymer composite separator layer and the outer regions have a lower or zero concentration of the inorganic solid electrolyte particles, according to some embodiments of the present disclosure. The softer outer regions are more conducive to a good contact between the separator and the anode or the cathode layer, thereby reducing the interfacial impedance.

Preferably, the inorganic solid electrolyte material is in a fine powder form having a particle size preferably from 10 nm to 30 μm (more preferably from 50 nm to 1 μm). The inorganic solid electrolyte material may be selected from an oxide type (e.g., perovskite-type), sulfide type, hydride type, halide type, borate type, phosphate type, lithium phosphorus oxynitride (UPON), Garnet-type, lithium superionic conductor (LISICON), sodium superionic conductor (NASICON), or a combination thereof.

The inorganic solid electrolytes that can be incorporated into a polymer matrix as an ion-conducting additive to make a separator include, but are not limited to, perovskite-type, NASICON-type, garnet-type and sulfide-type materials. A representative and well-known perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in an elastic polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc, In, Lu, Y or La). Al substitution has been demonstrated to be the most effective solid state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a brand series of garnet-type materials may be used as an additive, including Li₅La₃M₂O₁₂ (M=Nb or Ta), Li₆ALa₂M₂O₁₂ (A=Ca, Sr or Ba; M=Nb or Ta), Li_{5.5}La₃M_{1.75}B_{0.25}O₁₂(M=Nb or Ta; B═In or Zr) and the cubic systems Li₇La₃ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity if 1.02×10⁻³ Stem at room temperature.

The sulfide-type solid electrolytes include the Li₂S—SiS₂ system. The highest reported conductivity in this type of material is 6.9×10⁻⁴ S/cm, which was achieved by doping the Li₂S—SiS₂ system with Li₃PO₄. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer.

These solid electrolyte particles dispersed in an elastic polymer can help stop the penetration of lithium dendrites (if present) and enhance the lithium-ion conductivity of certain elastic polymers having an intrinsically low ion conductivity.

Preferably and typically, the thermally stable polymer has a lithium-ion conductivity no less than 10⁻⁵ S/cm, more preferably no less than 10⁻⁴ S/cm, further preferably no less than 10⁻³ S/cm, and most preferably no less than 10⁻² S/cm. The composite separator is a polymer matrix composite containing from 1% to 99% (preferably 30% to 95% and most preferably 60% to 90%) by weight of lithium ion-conducting solid electrolyte particles dispersed in or bonded by a polymer matrix material.

Typically, a thermally stable polymer is originally in a monomer or oligomer state that can be polymerized into a linear or branched polymer or cured to form a cross-linked polymer. Prior to curing, these polymers or oligomers are soluble in an organic solvent to form a polymer solution. An ion-conducting or electron-conducting additive may be added to this solution to form a suspension. This solution or suspension can then be formed into a thin layer of polymer precursor on a surface of an anode current collector or a solid substrate surface. The polymer precursor (monomer and initiator or oligomer and a crosslinker, etc.) is then polymerized and/or cured to form a cross-linked polymer. This thin layer of polymer may be tentatively deposited on a solid substrate (e.g., surface of a polymer or glass), dried, and separated from the substrate to become a free-standing polymer layer. This free-standing layer is then laid on a lithium foil/coating or implemented between an anode layer (e.g., a Si-based anode active material layer or a lithium film/coating) and a cathode layer. Polymer layer formation can be accomplished by using one of several procedures well-known in the art; e.g., spraying, spray-painting, printing, coating, extrusion-based film-forming, casting, etc.

For instance, the liquid monomer may comprise a flame retardant selected from an organic phosphorus compound, an inorganic phosphorus compound, a halogenated derivative thereof, or a combination thereof. The organic phosphorus compound or the inorganic phosphorus compound preferably is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

Polyphosphazenes, also commonly referred to as poly(organo)phosphazenes, are a family of inorganic molecular hybrid polymers based on a phosphorus—nitrogen backbone substituted with organic side groups which show a broad array of unique properties due to the vast array of organic substituents possible.

The method of synthesizing polyphosphazenes depends on the desired type of polyphosphazene. A wide variety of reactive phosphazene compounds are available as a potential reactive precursor material (monomer, oligomer, or reactive polymer). In the present specification, a reactive phosphazene compound can mean a monomer, oligomer, or reactive polymer that can be chemically reacted (i.e., can undergo polymerization, including copolymerization, functional group substitution, such as replacing Cl— with an organic or organometallic group, and/or crosslinking). A curing agent refers to an initiator, catalyst, substituent (e.g., an organic or organometallic group), and/or a crosslinking agent that enables the desired chemical reaction (polymerization, substitution, and/or crosslinking).

The most widely used method for linear phosphazene polymers is based on a two-step process. In the first step, as an example, hexachlorocyclotriphosphazene, (NPCl₂)₃ (Chemical formula 1) is heated in a sealed system at 250° C. to convert it to a long chain linear polymer, [NPCl₂]n (or Chemical formula 2), having typically 15,000 or more repeating units. This reaction is illustrated in the following Reaction 1:

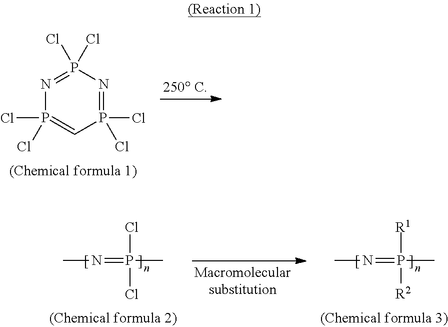

In the second step the chlorine atoms linked to phosphorus in the polymer are replaced by organic groups through reactions with R¹ or R² to form Chemical formula 3, where R¹ and R² are organic or organometallic groups (there is no particular restriction on the types of organic or organometallic groups that can be chosen). Preferably, R¹ and R² may be independently selected from alkoxides, aryloxides, amines, or organometallic groups, etc. Many different reagents (or called substituting agents or, simply “substituents”) can be used in this macromolecular substitution reaction and, hence, a large number of different polymers can be produced. All these polymers are herein referred to as a polyphosphazene. Some examples of the macromolecular substitution are shown below (Reactions 2a, 2b, and 2c):

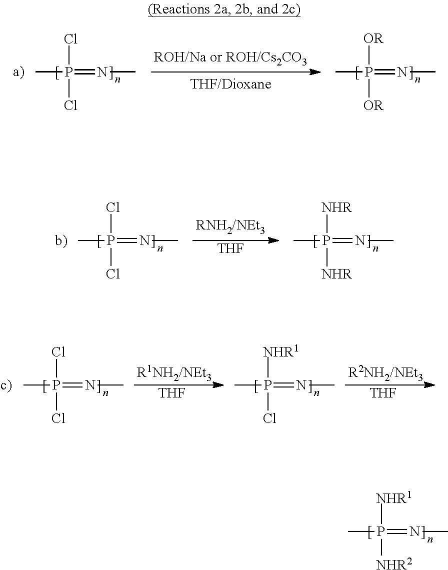

Polyphosphazene polymers include a wide range of hybrid inorganic-organic polymers with a number of different skeletal architectures that has the backbone —P—N—P—N—P—N—. In nearly all of these materials, two organic side groups are attached to each phosphorus center. Examples of phosphazene polymers include the following:
a) Linear polymers have the formula (N═PR¹R²)ₙ, where R¹ and R² are organic;
b) Cyclolinear and cyclomatrix polymers in which small phosphazene rings are connected together by organic chain units.
c) Block copolymer, star, dendritic, or comb-type structures.
   More than 700 different polyphosphazenes are known, with different side groups (R) and different molecular architectures.

For discussion purposes, polyphosphazenes may be conveniently divided into two major classes-those in which the side groups are attached to phosphorus via oxygen (P—OR) or nitrogen (P—NR₂) linkages and those in which the substituents are attached directly to phosphorus through phosphorus-carbon bonds, i.e., the poly(alkyl phosphazenes and poly(aryl phosphazenes). The present disclosure provides both types of polyphosphazenes as an ingredient in the quasi-solid or solid electrolytes.

In certain embodiments, the polymer comprises a polyphosphazene selected from the groups consisting of (a) linear polymers having the formula (N═PR¹R²)ₙ, where R¹ and R² are organic; (b) cyclolinear and cyclomatrix polymers in which small phosphazene rings are connected together by organic chain units; (c) block copolymer, star, dendritic, or comb-type structures; and combinations thereof.

In certain embodiments, the phosphazene compound is synthesized from a precursor monomer, oligomer, or reactive polymer selected from Chemical formula 1, Chemical formula 2, Chemical formula 3, Chemical formula 4, or a combination thereof:

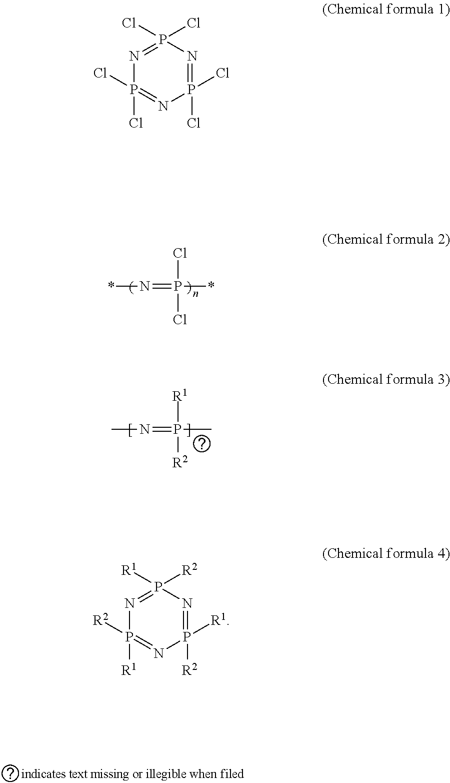

wherein R, R¹ and R² are independently selected from an organic group or an organometallic group.

In certain embodiments, the polymer contains a cross-linked network of a phosphazene compound crosslinked by a crosslinking agent to a degree of crosslinking that imparts an elastic tensile strain from 5% to 500%.

The crosslinking agent may be selected from poly(diethanol) diacrylate, poly(ethyleneglycol)dimethacrylate, poly(diethanol) dimethylacrylate, poly(ethylene glycol) diacrylate, N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid, acrylic acid, methacrylic acid, a derivative compound of acrylic acid, a derivative compound of methacrylic acid, glycidyl functions, N,N-Methylenebisacrylamide (MBAAm), Ethylene glycol dimethacrylate (EGDMAAm), isobornyl methacrylate, poly (acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate, an urethane chain, a chemical derivative thereof, or a combination thereof.

The polyphosphazene may be crosslinked by a crosslinking agent that comprises a compound having at least one reactive group selected from a phenylene group, a hydroxyl group, an amino group, an imino group, an amide group, an acrylic amide group, an amine group, an acrylic group, an acrylic ester group, or a mercapto group in the molecule.

In certain embodiments, the polymer in a thermally stable polymer composite separator may comprise a polyvinyl phosphonate polymer comprising chains derived from a phosphonate vinyl monomer. The polymer refers to a phosphorus-containing polymer functionalized at the side chain (herein referred to as a polyvinyl phosphonate), instead of that at the main chain or backbone chain (e.g., polyphosphazene having P in the main chain). The polyvinyl phosphonate herein also includes polyvinylphosphonic acid and its various copolymers. The phosphonate vinyl monomer also includes the vinylphosphonic acid monomer.

The phosphonate vinyl monomer may include allyl-type, vinyl-type, styrenic-type and (meth)acrylic-type monomers bearing phosphonate groups (i.e., either mono or bisphosphonate). In certain embodiments, the phosphonate vinyl monomer is selected from the group consisting of phosphonate bearing allyl monomers (e.g., Dialkyl allylphosphonate monomers and Dioxaphosphorinane allyl monomers), phosphonate bearing vinyl monomers (e.g., Dialkyl vinyl phosphonate monomers and Dialkyl vinyl ether phosphonate monomers), phosphonate bearing styrenic monomers (e.g., α-, (β-, and p-vinylbenzyl phosphonate monomers), phosphonate bearing (meth)acrylic monomers (e.g., phosphonate groups linked to the acrylate double bond, phosphonate groups linked to the ester, and phosphonate groups linked to the amide), vinylphosphonic acids, and combinations thereof. Examples of Phosphonate bearing (meth)acrylic monomers include α-(dialkylphosphonate) acrylate, β-(dialkylphosphonate) acrylate, dialkylphosphonate (meth)acrylate, and N-(dialkylphosphonate) (meth)acrylamide.

In some embodiments, the monomer is selected from phosphate, alkyl phosphonate, phosphazene, phosphit; e.g., tris(trimethylsilyl) phosphite (TTSPi), alkyl phosphate, triallyl phosphate (TAP), or a combination thereof. The phosphate or alkyl phosphonate may be selected from the following:

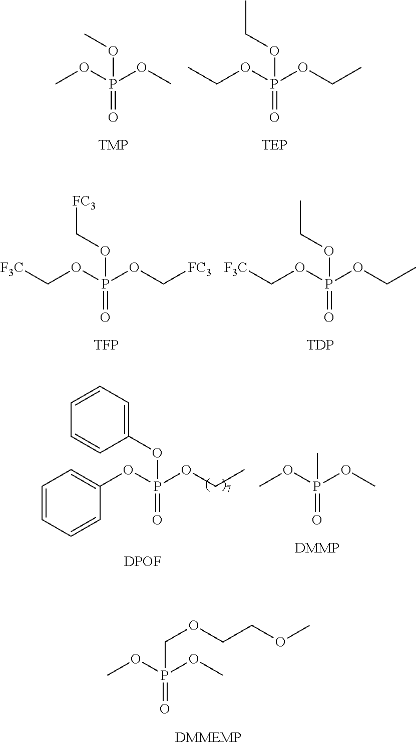

wherein these chemical species comprise end groups or functional groups having unsaturation for polymerization.

For the desired reactive phosphonate vinyl monomers, phosphonate moieties can be readily introduced into vinyl monomers to produce allyl-type, vinyl-type, styrenic-type and (meth)acrylic-type vinyl monomers bearing phosphonate groups (e.g., either mono or bisphosphonate) in the side chain.

First example of phosphonate bearing allyl monomers include Dialkyl allylphosphonate monomers, which can be produced by following Reaction schemes 3A, 3B and 3C, shown below:

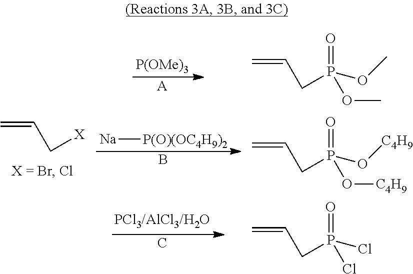

The radical homopolymerization of dialkylphosphonate allyl monomers in the presence of chain transfer agents (CTAs) tends to result in low molecular weight oligomers. In order to be efficiently polymerized, dialkylphosphonate allyl monomers have to be involved in radical copolymerizations in the presence of electron-accepting monomers. For instance, low molecular weight copolymers (about 7 000 g mol:1) can be produced by radical copolymerization of diethyl-1-allyl phosphonate with maleic anhydride. These copolymers are a good choice for use as an electrolyte, which shows excellent flame retardant effects.

As examples of dioxaphosphorinane allyl monomers, dioxaphosphorinanes bearing P-alkyl or P-aryl groups may be synthesized according to the following Reactions 4-5:

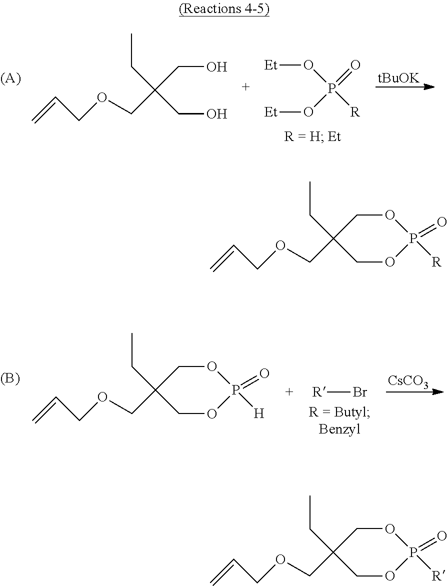

When R is an alkyl or phenyl group, dioxaphosphorinane allyl monomers can undergo radical polymerization that leads to adducts, especially in the presence of chain transfer agents. These oligomers showed a high content of residue from thermal gravimetric analysis, and thus could be employed as an electrolyte ingredient having good flame retardant characteristics. However, when R═H, a high degree of polymerization could be achieved.

Examples of phosphonate bearing vinyl monomers include Dialkyl vinyl phosphonate monomers, which can be produced according to Reactions 6-8.

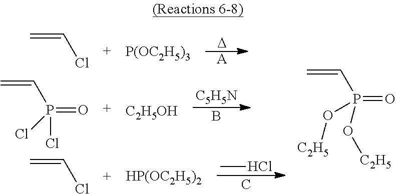

Thiol-ene reaction may be used to polymerize vinyl phosphonate monomers by using CTAs. However, it is more efficient to carry out radical copolymerization of diethyl vinyl phosphonate (DEVP) with styrene carried out at 100° C., which can result in copolymers with a high molecular weight. When DEVP is copolymerized with styrene or acrylonitrile in emulsion, copolymers showed Mw values up to 100, 000 g mol/1.

Dimethyl vinyl phosphonate as examples of Dialkyl vinyl ether phosphonate monomers may be produced according to Reactions 9-10.

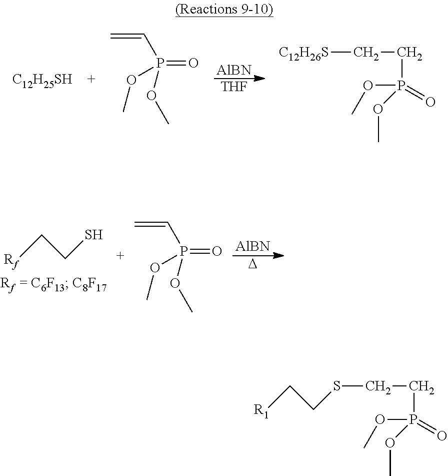

Vinyl ether monomers are good candidates in order to reach high molecular weight polymers either by cationic homopolymerization or by radical copolymerization (when associated with an electron-accepting monomer). The polymerization may be conducted by reaction of chloroethyl vinyl ether with triethylphosphite.

As examples of phosphonate bearing styrenic monomers, dimethylvinylbenzyl phosphonate can be produced in a high yield from vinylbenzyl chloride (VBC) according to Reactions 11-12 below:

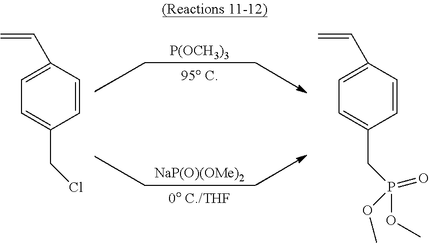

The radical homopolymerization of diethylbenzyl phosphonate (DEVP) may be conducted in the presence of chain transfer agents in order to control both the chain length and the chain-end functionality. The p-Vinylbenzyl phosphonate monomers are used in radical copolymerization as a co-monomer, bringing the specific properties of the phosphonate groups. For instance, DEVP-acrylonitrile copolymers are an effective flame-retardant compound. The phosphonate moieties will act as a nucleophilic non-volatile phosphorus-containing residue, and will be able to promote cross-linking. Indeed, poly(acrylonitrile) cyclizes at high temperatures and thus becomes more thermally stable; this intracyclization is enhanced by the presence of phosphonic species.

The p-benzyl alkyl phosphonate monomers may participate in radical copolymerization with N-heterocycle monomers, such as 1-vinylimidazole:

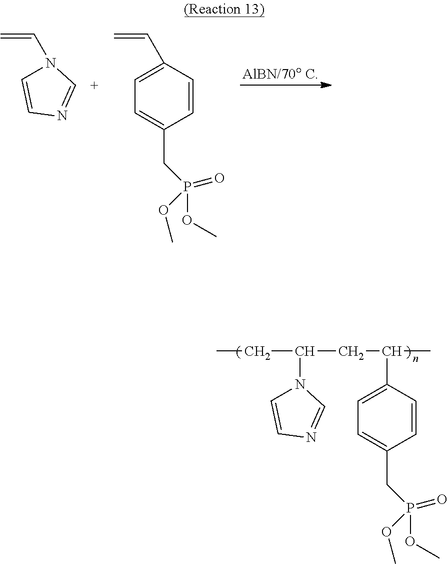

Phosphonate bearing (meth)acrylic monomers exhibit high reactivity in radical polymerization, due to the activation of the (meth)acrylic double bond by the polar substituent. Phosphonate bearing (meth)acrylic monomers can be classified according to either the double bond (acrylic, acrylonitrile, acrylamide, etc.) or to the phosphonate linkage (linked the double bond, to the ester group, etc.).

Phosphonate bearing (meth)acrylic monomers may be obtained according to reactions 14-18:

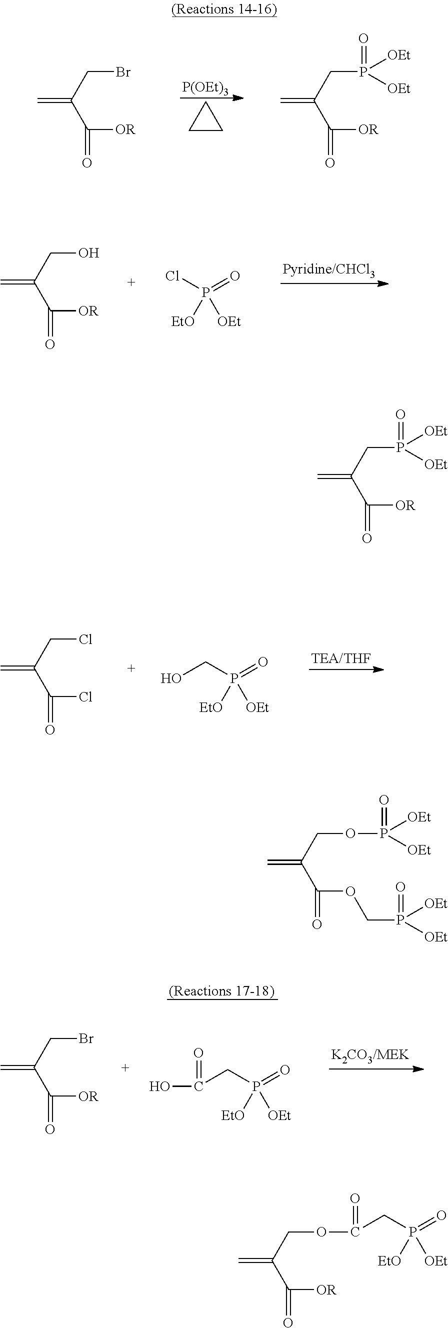

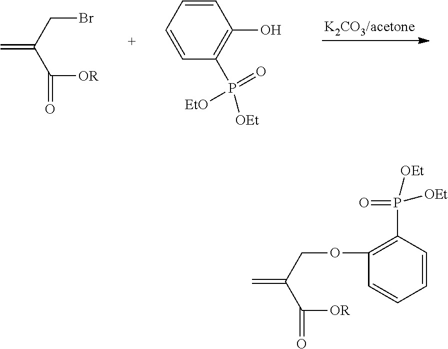

Homopolymerization of β-(dialkylphosphonate) acrylate monomers can be slow but lead to good yields. The reduction of the rate of polymerization may be due to the occurrence of chain transfer processes, which decreases the molecular weight values.

The initiators for anionic or bulk polymerization of these monomers may be selected from n-C₄H₉Li, (C₅H₅)₂Mg, or (i-C₄H_{q})₃Al, carbenium salts, and certain lithium salts. The reactions may be conducted at a temperature from −60° C. to 30° C., leading to high molecular weights, typically from 3×10³ to 10⁵. Cationic polymerization may be initiated with CF₃SO₃CH₃, CF₃SO₃C₂H₅, (CF₃SO₂)O, Ph₃C⁺ AsF₆⁻, and certain other lithium salts, leading to colored, oily products with number average molecular weights typically up to 10³.

In certain embodiments, the polymer comprises chains of a polyester of phosphoric acid, represented by the following structure (Chemical formula 5 or formula 6):

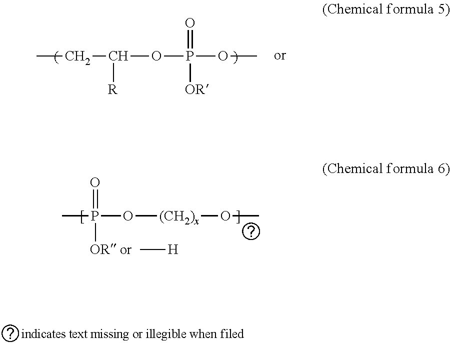

wherein 2≤x≤10, R is selected from Li, H, a methyl, ethyl, propyl, vinyl, allyl, acrylate, alkyl, aryl, or CH₂Cl, and R′ or R″ is independently selected from Li, CH₃, C₂H₅, n-C₃H₇, i-C₃H₇; n-C₄H₉, CCl₃CH₂, C₆H₅, —OH, —COOH, —O—CH₂CH₂—R′″, an alkyl, or an aryl, where R′″═—(CH₂)_{y}CH₃ and 0≤y≤10.

The monomers for the preparation of polyester of phosphoric acid may include the two cyclic phosphate esters—phospholanes (I) and phosphorinanes (II)—five- and six-membered cyclic compounds, respectively, and their derivatives. According to the UPAC nomenclature, the names of these compounds are 2-alkoxy (or phenoxy)-2-oxo-1,3,2-dioxaphospholane (I) and 2-alkoxy (or phenoxy)-2-oxo-1,3,2-dioxaphosphorinane (II).

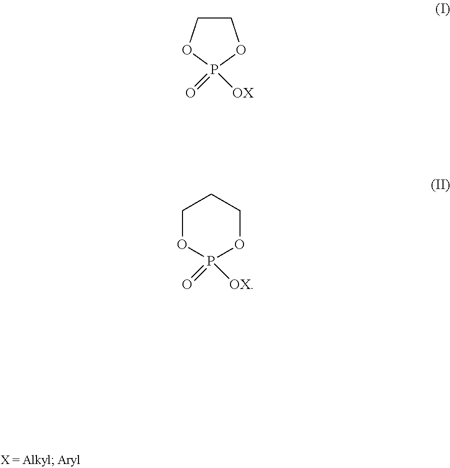

Phosphonate moieties can be readily introduced into vinyl monomers to produce allyl-type, vinyl-type, styrenic-type and (meth)acrylic-type liquid solvents bearing phosphonate groups (e.g., either mono or bisphosphonate). Examples include diethyl vinylphosphonate, dimethyl vinylphosphonate, vinylphosphonic acid, diethyl allyl phosphate, and diethyl allylphosphonate:

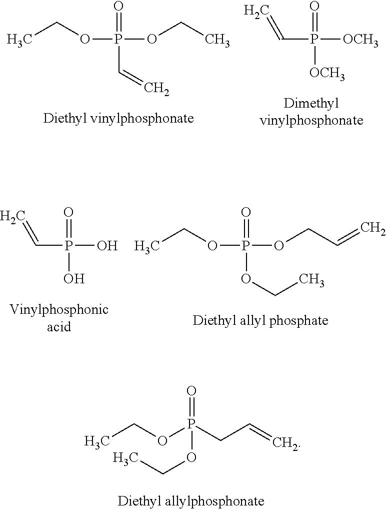

Representative monomers for the preparation of a polyester of phosphoric acid include 2-Alk(aryl)oxy-2-oxo-1,3,2-dioxaphospholans:

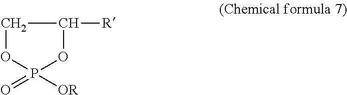

wherein R is selected from Li, H, a methyl, ethyl, propyl, vinyl, allyl, acrylate, alkyl, aryl, or CH₂Cl, and R′ is selected from Li, CH₃, C₂H₅, n-C₃H₇, i-C₃H₇; n-C₄H₉, CCl₃CH₂, C₆H₅, —OH, —COOH, —O—CH₂CH₂—R^{′″}, alkyl, aryl, where R^{′″}═—(CH₂))CH₃ and 0≤y≤10.

The initiators for anionic or bulk polymerization of these monomers may be selected from n-C₄H₉Li, (C₅H₅)₂Mg, or (i-C₄H₉)₃Al, carbenium salts, and certain lithium salts. The reactions may be conducted at a temperature from −60° C. to 30° C., leading to high molecular weights, typically from 3×10³ to 10⁵. Cationic polymerization may be initiated with CF₃SO₃CH₃, CF₃SO₃C₂H₅, (CF₃SO₂)O, Ph₃C⁺ AsF₆, and certain other lithium salts, leading to colored, oily products with number average molecular weights typically up to 10³. The initiator may comprise a lithium salt selected from lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof. In other words, we have surprisingly observed that certain lithium salts actually participate in the polymerization reactions.

The initiator or a co-initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tort-butyl peroxypivalate, diisopropyl peroxydicarbonate, or a combination thereof.

In addition to an initiator, the reactive monomer solution for the preparation of the presently disclosed high-elasticity polymer may further comprise a curing agent (a crosslinking agent or co-polymerization species) selected from an amide group, such as N,N-dimethylacetamide, N,N-diethylacetamide, N,N-dimethylformamide, N,N-diethylformamide, or a combination thereof. The crosslinking agent may comprise a compound having at least one reactive group selected from a hydroxyl group, an amino group, an imino group, an amide group, an acrylic amide group, an amine group, an acrylic group, an acrylic ester group, or a mercapto group in the molecule. In certain embodiments, the crosslinking agent is selected from poly(diethanol) diacrylate, poly(ethyleneglycol)dimethacrylate, poly(diethanol) dimethylacrylate, or poly(ethylene glycol) diacrylate.

The crosslinking agent preferably comprises a compound having at least one reactive group selected from a hydroxyl group, an amino group, an imino group, an amide group, an amine group, an acrylic group, or a mercapto group in the molecule. The amine group is preferably selected from Chemical Formula 8:

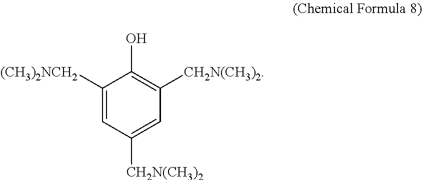

The crosslinking agent is preferably selected from N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid (Formula 4 below), acrylic acid, methacrylic acid, a derivative compound of acrylic acid, a derivative compound of methacrylic acid (e.g. polyhydroxyethylmethacrylate), glycidyl functions, N,N′-Methylenebisacrylamide (MBAAm), Ethylene glycol dimethacrylate (EGDMAAm), isobornyl methacrylate, poly (acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate (e.g. methylene diphenyl diisocyanate, MDI), an urethane chain, a chemical derivative thereof, or a combination thereof.

In some embodiments, the liquid monomer is selected from a phosphate, phosphonate, phosphinate, phosphine, or phosphine oxide having the structure of:

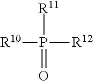

wherein R¹⁰,R¹¹, and R¹², can be designed to contain polymerizable double bonds or triple bonds and can be independently selected from the unsaturated (polymerizable) versions of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups.

In some embodiments, the monomer or oligomer comprises a phosphoranimine having the structure of:

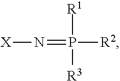

wherein R¹, R², and R³ are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, wherein R¹, R², and R³ are represented by at least two different substituents and wherein X is selected from the group consisting of an organosilyl group or a tert-butyl group. The R¹, R², and R³ may be each independently selected from the group consisting of an alkoxy group, and an aryloxy group. At least one of R¹, R², and R³ must have an unsaturation (double or triple bond) or a ring structure that can be opened up for polymerization (chain linking).

Preferably, the lithium salt occupies 0.1%-30% by weight and the crosslinking agent and/or initiator occupies 0.1-50% by weight of the reactive polymer precursor. It may be advantageous for these materials to form a lightly cross-linked network of polymer chains. In other words, the network polymer or cross-linked polymer should have a relatively low degree of cross-linking or low cross-link density to impart a high elastic deformation.

The polymer may contain a simultaneous interpenetrating network (SIN) polymer, wherein two cross-linking chains intertwine with each other, or a semi-interpenetrating network polymer (semi-IPN), which contains a cross-linked polymer and a linear polymer.

The aforementioned polymer can be mixed with a broad array of elastomers, lithium ion-conducting materials, and/or strengthening materials (e.g., glass fibers, ceramic fibers or particles, polymer fibers, such as aramid fibers).

A broad array of elastomers can be mixed with a thermally stable polymer to form a blend, co-polymer, or interpenetrating network that serves to bond the inorganic solid particles together as a separator layer. The elastomeric material may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The urethane-urea copolymer film usually consists of two types of domains, soft domains and hard ones. Entangled linear backbone chains consisting of poly (tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

In some embodiments, a thermally stable polymer can form a polymer matrix composite containing a lithium ion-conducting additive dispersed in the high-elasticity polymer matrix material, wherein the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0≤x≤1, 1≤y≤4.

In some embodiments, the thermally stable polymer can be mixed with a lithium ion-conducting additive, which contains a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

The presently disclosed lithium secondary batteries can contain a wide variety of cathode active materials. The cathode active material layer may contain a cathode active material selected from an inorganic material, an organic material, a polymeric material, or a combination thereof.

The inorganic material may be selected from a metal oxide, metal phosphate, metal silicide, metal selenide, transition metal sulfide, sulfur, lithium polysulfide, selenium, lithium selenide, or a combination thereof.

The inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The inorganic material may be selected from a lithium transition metal silicate, denoted as Li₂MSiO₄ or Li₂MaₓMb_{y}SiO₄, wherein M and Ma are selected from Fe, Mn, Co, Ni, or V, Mb is selected from Fe, Mn, Co, Ni, V, Ti, Al, B, Sn, or Bi; and x+y≤1.

Examples of the lithium transition metal oxide- or lithium mixed transition metal oxide-based positive active materials include: Li (M′ₓM“_{y})O₂, where M′ and M” are different metals (e.g., Li(NiₓMn_{Y})O₂, Li(Ni_{1/2}Mn_{1/2})O₂, Li(CrₓMn₁₋ₓ)O₂, Li(AlₓMn₁₋ₓ)O₂), Li(CoₓM_{1-X})O₂, where M is a metal, (e.g. Li(CoₓNi₁₋ₓ)O₂ and Li(CoₓFe₁₋ₓ)O₂), Li_{1-w}(MnₓNi_{Y}Co_{Z})O₂, (e.g. Li(CoₓMn_{y}Ni (_{1-x-y}))O₂, Li(Mn_{1/3}Ni_{1/3}CO_{1/3})O₂, Li(Mn_{1/3}Ni_{1/3}CO_{1/3-x}Mgₓ)O₂, Li(Mn_{0.4}Ni_{0.4}CO_{0.2})O₂, Li(Mn_{0.1}Ni_{0.1}Co_{0.8})O₂), Li_{1-w}(MnₓNiₓCo₁₋₂ₓ)O₂, Li_{1-w} MnₓNi_{Y}CoAl_{w})O₂, Li_{1-w} (NiₓCo_{Y}Al_{Z})O₂, where W=0−1, (e.g., Li(Ni_{0.8}Co_{0.15}Al_{0.05})O₂), Li_{1-w}(Ni_{X}Co_{Y}M_{Z})O₂, where M is a metal, Li_{1-w} (Ni_{X}Mn_{Y}M_{Z})O₂, where M is a metal, Li(Ni_{X}Mn_{Y}Cr₂₋ₓ)O₄, LiM′M″₂O₄, where M′ and M″ are different metals (e.g., LiMn_{2-Y-Z} Ni_{Y}O₄, LiMn_{2-Y-Z} Ni_{Y}Li_{Z}O₄, LiMn_{1.5}Ni_{0.5}O₄, LiNiCuO₄, LiMn₁₋ₓAl_{1-X}Al_{X}O₄, LiNi_{0.5}Ti_{0.5}O₄, Li_{1.05}Al_{0.1}Mn_{1.85}O_{4-z} F_{z}, Li₂MnO₃) LiₓV_{Y}O_{Z}, e.g. LiV₃O₈, LiV₂O₅, and LiV₆O₁₃. This list includes the well-known lithium nickel cobalt manganese oxides (NCM) and lithium nickel cobalt manganese aluminum oxides (NCM), among others.

The metal oxide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

In certain desired embodiments, the inorganic material is selected from a lithium-free cathode material. Such an initially lithium-free cathode may contain a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In these cases, it is particularly desirable to have the anode active material prelithiated to a high level, preferably no less than 50%. In some preferred embodiments, prelithiated anode comprises Si that is prelithiated to approximately 60-100% and the cathode comprises a cathode active material that is initially lithium-free.

The inorganic material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The inorganic material may be selected from a transition metal dichalcogenide, a transition metal trichalcogenide, or a combination thereof. The inorganic material may be selected from TiS₂, TaS₂, MoS₂, NbSe₃, MnO₂, CoO₂, an iron oxide, a vanadium oxide, or a combination thereof.

The metal oxide or metal phosphate may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The organic material or polymeric material may be selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer is selected from Poly[methanetetryl-tetra(thiomethylene)] (PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain consisting of conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

The organic material may contain a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

The working electrolyte used in the lithium battery may be a liquid electrolyte, polymer gel electrolyte, solid-state electrolyte (including solid polymer electrolyte, inorganic electrolyte, and composite electrolyte), quasi-solid electrolyte, ionic liquid electrolyte. The liquid electrolyte or polymer gel electrolyte typically comprises a lithium salt dissolved in an organic solvent or ionic liquid solvent. There is no particular restriction on the types of lithium salt or solvent that can be used in practicing the present disclosures.

Some particularly useful lithium salts are lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

There are a wide variety of processes that can be used to produce layers of polymer composite separators. These include coating, casting, painting, spraying (e.g. ultrasonic spraying), spray coating, printing (screen printing, 3D printing, etc.), tape casting, etc.

In certain embodiments, the process for manufacturing elastic composite separators may comprise (A) dispersing particles of an inorganic solid (e.g., solid electrolyte particles) in a liquid reactive mass of a polymer precursor (precursor to a thermally stable polymer) to form a slurry; (B) dispensing and depositing a layer of the liquid reactive mass onto a solid substrate surface; and (C) polymerizing and/or crosslinking the reactive mass to form a layer of polymer composite separator.

The solid substrate may be an anode current collector, an anode active material layer, or a cathode active material layer. In other words, this polymer composite separator can be directly deposited onto a layer of anode active material, an anode current collector, or a layer of cathode active material. This is achievable because curing of the polymer does not require a high temperature; curing temperature typically lower than 300° C. or even lower than 100° C. This is in stark contrast to the typically 900-1,200° C. required of sintering an inorganic solid electrolyte to form a ceramic separator. In addition, the presently disclosed separator is at least as good as a ceramic separator in terms of reducing interfacial impedance and stopping dendrite penetration.

Preferably, the process is a roll-to-roll process wherein step (B) comprises (i) continuously feeding a layer of the solid substrate (e.g. flexible metal film, plastic film, etc.) from a feeder roller to a dispensing zone where the reactive mass is dispensed and deposited onto the solid substrate to form a continuous layer of the reactive mass; (ii) moving the layer of the reactive mass into a reacting zone where the reactive mass is exposed to heat, ultraviolet (UV) light, or high-energy radiation (e.g., electron beam) to polymerize and/or cure the reactive mass to form a continuous layer of polymer composite; and (iii) collecting the polymer composite on a winding roller. This process is conducted in a reel-to-reel manner.

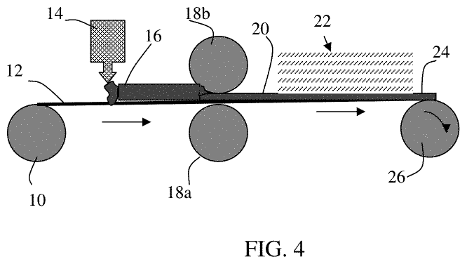

In certain embodiments, as illustrated in FIG. 4, the roll-to-roll process may begin with continuously feeding a solid substrate layer 12 (e.g. PET film) from a feeder roller 10. A dispensing device 14 is operated to dispense and deposit a reactive mass 16 (e.g. slurry) onto the solid substrate layer 12, which is driven toward a pair of rollers (18a, 18b). These rollers are an example of a provision to regulate or control the thickness of the reactive mass 20. The reactive mass 20, supported on the solid substrate, is driven to move through a reacting zone 22 which is provided with a curing means (heat, UV, high energy radiation, etc.). The partially or fully cured polymer composite 24 is collected on a winding roller 26. One may unwind the roll at a later stage.

The process may further comprise cutting and trimming the layer of polymer composite into one or multiple pieces of polymer composite separators.

The process may further comprise combining an anode, the polymer composite separator, an electrolyte, and a cathode electrode to form a lithium battery.

The lithium battery may be a lithium metal battery, lithium-ion battery, lithium-sulfur battery, lithium-selenium battery, lithium-air battery, etc. The cathode active material in the lithium-sulfur battery may comprise sulfur or lithium polysulfide.

### EXAMPLE 1: Preparation of Solid Electrolyte Powder, Lithium Nitride Phosphate Compound (LiPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form.

### EXAMPLE 2: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting solid electrolyte material was then subjected to grinding in a mortar to form a powder sample to be later added as an inorganic solid electrolyte particles dispersed in an intended elastic polymer matrix (examples of thermally stable polymers are given below).

### EXAMPLE 3: Preparation of Garnet-Type Solid Electrolyte Powder

The synthesis of the c-Li₆₂₅Al₀₂₅La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736). For the synthesis of cubic garnet particles of the composition c-Li₆₂₅Al₀₂₅La₃Zr₂O₁₂, stoichiometric amounts of LiNO₃, Al(NO₃)₃-9H₂O, La(NO₃)₃-6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li₆₂₅Al₀₂₅La₃Zr₂O₁₂, which was ground to a fine powder in a mortar for further processing.

The c-Li₆₂₅Al₀₂₅La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li₆₂₅Al₀₂₅La₃Zr₂O₁₂ (LLZO) in a powder form was dispersed in several ion-conducting polymers discussed in below examples.

### EXAMPLE 4: Preparation of Sodium Superionic Conductor (NAS ICON) Type Solid Electrolyte Powder

The Na_{3.1}Zr_{1.95}M_{0.05}Si₂PO₁₂(M Mg, Ca, Sr, Ba) materials were synthesized by doping with alkaline earth ions at octahedral 6-coordination Zr sites. The procedure employed consists of two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### EXAMPLE 5: Composite Separator Layer Based on a Phosphazene Polymer Binder/Matrix of the General Formula [—NP(A)a(B)b-]ₓ

In a representative procedure, a 1-liter flask equipped with a thermometer, a stirrer, a dropping funnel and a condenser was charged with 58.0 g (0.167 mole) of hexachlorotriphosphazene, 50 ml of toluene and 158 g (2.0 moles) of pyridine, and the mixture was stirred. To the mixture was dropwise added 143 g (1.1 moles) of 2-hydroxyethyl methacrylate (HEMA) through the dropping funnel. The mixture was heated to 60° C. and the reaction was continued for 8 hours with stirring. After precipitated crystalline materials were filtered off, the solvent in the filtrate was distilled off under reduced pressures. The residual solution was dried to a desired level, leaving 136 g (yield: 91%) of a curable phosphazene compound in the form of a solution having a yellow color.

A benzol peroxide initiator (0.5% by weight) was added to the curable phosphazene compound in toluene to produce solution No. 1. A lithium salt, lithium hexafluorophosphate (LiPF₆), was dissolved in fluoroethylene carbonate (FEC) to form a 1.0 M solution (Solution No. 2). The lithium salt amount was varied to result in a final lithium salt-to-polyphophazene ratio from 5/100 to 25/100. Solution No. 1 and Solution No. 2, along with a desired amount of an inorganic filler (nano particles of TiO₂, Al₂O₃, SiO₂, and LLZO, separately) were then mixed, well stirred, and cast onto a glass surface to form reactive layers, which were cured and dried at 60° C. overnight. A separator layer was then laminated between a Cu foil and a cathode active layer for use in an anode-less lithium battery (initially the cell being lithium-free) containing a NCM-532 cathode. Another protective layer was disposed between a Cu foil-supported lithium metal foil and a separator in a lithium-sulfur cell.

### EXAMPLE 6: Composite Separator Layer Based on a Phosphazene Polymer Binder/Matrix of the General Formula [—NP(A)a(B)b-]ₓ

A 1-liter flask equipped with a thermometer, a stirrer, a dropping funnel and a condenser was charged with 100 ml of tetrahydrofuran and 11.6 g (0.5 mole) of metallic sodium. To this mixture was dropwise added 55.5 g (0.55 mole) of 2,2,2-trifluoroethanol, and the mixture was then reacted under reflux until sodium was completely consumed. To this reaction mixture was dropwise added a solution of 39.6 g (0.111 mole) of hexachlorotriphosphazene in 100 ml of toluene, and the mixture was reacted under reflux for 2 hours. Thereafter, the temperature of the reaction mixture was dropped to room temperature and 191 g (1.47 mole) of HEMA was dropwise added to the reaction mixture slowly using the dropping funnel. The mixture was then heated to 60° C. and the reaction was continued for 8 hours at that temperature with stirring. Thereafter, precipitated crystalline materials and the catalyst were filtered off and the solvent in the filtrate was distilled off under reduced pressure. The residual solution was dried to a sufficient level, leaving 88 g (yield: 93%) of a curable phosphazene compound in the form of a solution having a yellow color.

A benzol peroxide initiator (0.5% by weight), lithium bis(oxalato)borate (LiBOB), and curable phosphazene compound (ratio of 0.5/10/100) were dispersed in a mixture of vinylene carbonate (VC) and toluene to form a 1.0 M solution. Fine particles of NASICON-type solid electrolyte were then added into the solution to form a slurry. The slurry was directly cast over a graphene-modified Cu foil surface to form a reactive layer. Most (>80%) of the solvents were removed with the assistance of a vacuum pump. The reactive mass was cured at 65° C. overnight. Two types of battery cells were studied in this example: a lithium/NCM-811 cell (initially the cell being lithium-free at the anode side) and a lithium/NCA cathode (initially lithium-free at the anode).

### EXAMPLE 7: Composite Separator Layers Based on Poly[Bis(2-Hydroxyethyl-Methacrylate)-Phosphazene] and Poly[(2-Hydroxyethyl-Methacrylate)-Graft-Poly(Lactic-Acid)-Phosphazene]

Poly[bis(2-hydroxyethyl-methacrylate)-phosphazene] was obtained by nucleophilic condensation reactions at different concentrations of the substituents. Specifically, the scheme of the poly(organophosphazenes) synthesis by nucleophilic substitution is shown in Reaction 1 earlier. The single substituted and co-substituted poly(dichlorophosphazenes) (PZs) were obtained from poly(dichlorophosphazene), which was produced by melt ring-opening polymerization of hexachlorocyclotriphosphazene (HCCP) under vacuum at 250° C. for 3 h. After this time, the polymer was dissolved at room temperature in anhydrous THF, and it was separated by precipitation into n-heptane.

The substitution of poly(dichlorophosphazene) (PZ) with pentaerythritol triacrylate (PEATA) was made at two molar ratios: 1:3 and 1:6 mmol PZ-PEATA. Triethylamine (TEA) was added at 1:1 mmol ratio PEATA: TEA as effective acceptor to trap hydrogen chloride. The PZ was dissolved in THF (10 mL) under stirring, after 10 min PEATA and TEA were added and the glass vial reactor was kept for two days at room temperature. The product was purified following the procedure described for PZ.

A methyl amine initiator (0.5% by weight), lithium bis(oxalato)borate (LiBOB), and curable phosphazene compound (ratio of 0.5/10/100) were dispersed in a mixture of vinylene carbonate (VC) and toluene to form a 1.0 M solution. The solution, along with particles of an inorganic filler (LGPS-type solid electrolyte particles) dispersed therein, was cast onto a glass surface. Most (>80%) of the solvents were removed with the assistance of a vacuum pump. The resin was cured at 65° C. overnight. Three types of battery cells were studied in this example: a lithium/NCM-811 cell (initially the cell being lithium-free), a Si/NCM-811 Li-ion cell, and a lithium-sulfur cell.

### EXAMPLE 8: Polyphosphazene Polymer from 2,2,4,4,6,6-Hexakis(Vinyloxyethylenoxy)-2,2,4,4,6,6-Hexahydro-1,3,5,2,4,6-Triazatriphosphorine

The compound 2,2,4,4,6,6-Hexakis(vinyloxyethylenoxy)-2,2,4,4,6,6-hexahydro-1,3,5,2,4,6-triazatriphosphorine is prepared by the following reactions:

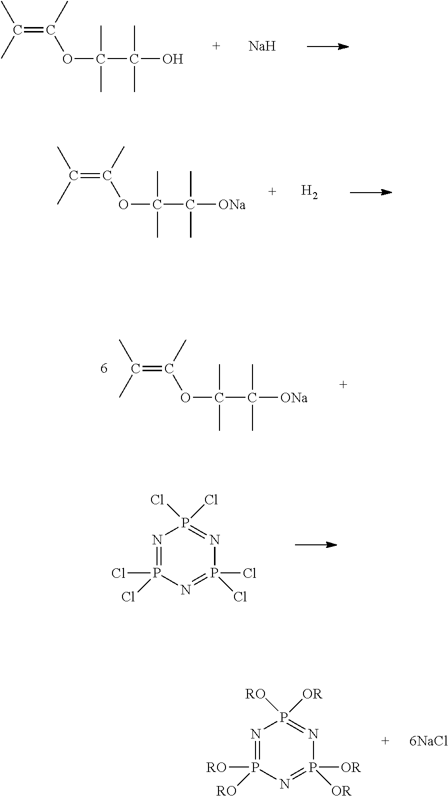

where R=the following structure:

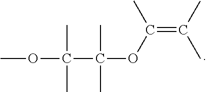

In a representative procedure, 16.80 g (0.10 mole) of sodium hydride (95%) was suspended in 700 ml of anhydrous THF and/or argon in a 2-liter three-necked flask with internal thermometer, dropping funnel, and reflux condenser. While cooling in an ice bath, 61.67 g (0.70 mole) of ethylene glycol mono-vinyl ether was then added slowly through a dropping funnel over a period of 90 min. Stirring was then continued at about 50° C. for a total of 20 h. The contents of the flask gradually exhibited a brown color.

Subsequently, a solution of 34.79 g (0.10) mole of phosphonitrile chloride (NPCl₂)₃ in 200 ml of anhydrous THF was added slowly (90 min) through a dropping funnel. Water bath cooling was necessary during this addition to keep the temperature below 30° C. Stirring was continued for 1 h at room temperature, and the batch was then heated to an internal temperature of 50° C. Stirring was continued overnight (total 24 h) at this temperature.

The mixture was then allowed to cool to room temperature and was filtered by suction. Almost all of the THF was removed from the brown filtrate in a rotary evaporator; 250 ml of diethyl ether and 250 ml of deionized water were added, and the mixture was transferred to a separatory funnel. The ether phase was separated, and the aqueous phase was extracted two more times with 125 ml portions of diethyl ether. The combined ether phases were shaken three times with 50 ml portions of deionized water, which can lighten the mixture considerably. The ether phase was separated and dried over sodium sulfate. After filtering off the drying agent and evaporating the solvent in a rotary evaporator, 62.84 g of a clear yellow liquid was obtained. The product may be further purified if so desired. The product is readily soluble in chloroform, tetrahydrofuran, diethyl ether, isopropanol, ethyl acetate, and toluene. The phosphazene derivatives herein produced, along with an optional lithium salt (e.g., 10% lithium borofluoride (LiBF₄) or lithium trifluoro-methanesulfonate (LiCF₃SO₃)) were then dissolved in solvents, such as ethyl acetate (EA), fluoroethylene carbonate (FEC), and hydrofluoroether (HFE), to produce precursor or reactive liquid compositions.

The reactive liquid compositions, along with particles of an inorganic filler, were cast over a Cu foil surface and then stacked with a cathode layer of NCM-622 particles. The cell was then irradiated with electron beam at room temperature until a total dosage of 40 Gy was reached. In-situ crosslinking of the polyphosphazene polymer layer in the anode was accomplished. Crosslinked networks are capable of holding any liquid electrolyte in place, preventing any leakage issue.

Additionally, polymer films were cast on a glass surface and some of the films were subjected to the same dosage of electron beams. The room temperature lithium-ion conductivity values of the polymers (each containing approximately 10% by weight lithium salt, LiBF₄) were increased from approximately 3.8×10⁻⁴ S/cm for un-crosslinked polymer to approximately 2.6×10⁻³ S/cm for electron beam-cured polymers.

Electrochemical measurements (CV curves) were carried out in an electrochemical workstation at a scanning rate of 1-100 mV/s. The electrochemical performance of the cells was evaluated by galvanostatic charge/discharge cycling at a current density of 50-500 mA/g using an Arbin electrochemical workstation. Testing results indicate that the cells containing a protective layer obtained by in situ curing perform very well in terms of cycling stability and the energy storage capacity and yet these cells are flame resistant and relatively safe.

### EXAMPLE 9: Solid Electrolyte Separators Containing Homo-Polymers and Copolymers from Vinyl Ether Phosphazene Derivatives

Flame-resistant protective layer compositions were prepared from vinyl ether phosphazene derivative with mixed substitution according to the following reactions:

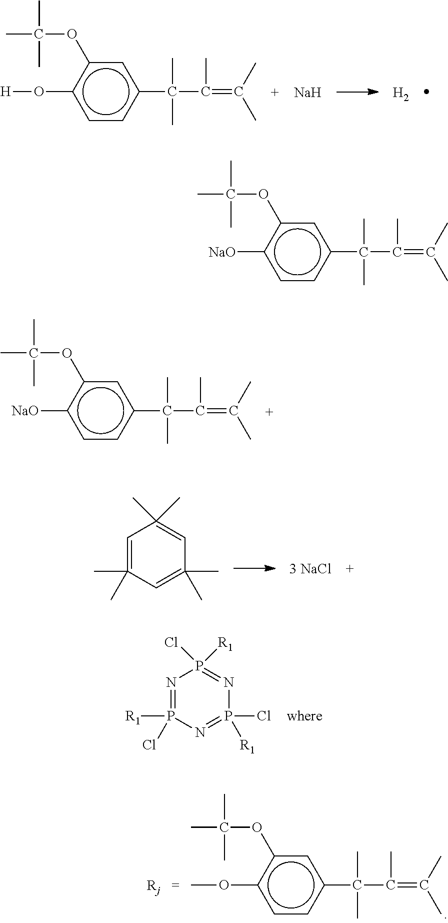

In a representative procedure, 9.60 g (0.40 mole) of sodium hydride was placed in a 1000-ml three-necked flask with KPG stirrer, dropping funnel, and internal thermometer, and was slurred with 100 ml of anhydrous tetrahydrofuran. While cooling with ice/salt, a solution of 65.68 g (0.40 mole) of eugenol in 50 ml of anhydrous tetrahydrofuran (THF) was then added dropwise (gas evolution, addition time 45 min). Stirring was continued for 1 h at room temperature, and then a solution of 46.36 g (0.133 mole) of (NPCl₂)₃ in 150 ml of anhydrous THF was added.

The mixture was stirred for 60 h at room temperature, transferred to a single-necked flask, and the solvent is evaporated by rotation. The product was taken up in 150 ml of diethyl ether and 150 ml of deionized water, and the phases were separated in a separatory funnel. The aqueous phase was washed twice with 10 ml portions of deionized water. The combined orange-colored ether phases were dried over anhydrous sodium sulfate. The drying agent was filtered off and the clear filtrate was stirred for 30 min at room temperature with activated charcoal. After repeated filtration and solvent removal by rotary evaporation, 94 g of a viscous, clear, brown-colored liquid was obtained. The product may be further filtered through a short silica gel column if so desired. The product has a molecular weight 730.89 g/mole and is readily soluble in toluene, chloroform, ethyl acetate, diethyl ether, tetrahydrofuran, and acetone, etc.

The vinyl ether phosphazene derivatives herein produced, along with a lithium salt (e.g., 10% lithium borofluoride (LiBF₄)), were then dissolved in a solvent, such as ethyl acetate (EA), fluoroethylene carbonate (FEC), and hydrofluoroether (HFE), to produce precursor or reactive compositions for separator layers. In several samples, a garnet-type solid electrolyte (Li₇La₃Zr₂O₁₂ (LLZO) powder) was added into the reactive slurry to form polymer composite separator layers.

### EXAMPLE 10: Polyphosphazene Composite Separator Layers were Prepared from [NPCl₂]ₙ and a Propylene Oxide Oligomer

The polyphosphazene polymer was prepared from [NPCI₂]ₙ and a propylene oxide oligomer according to the following reaction:

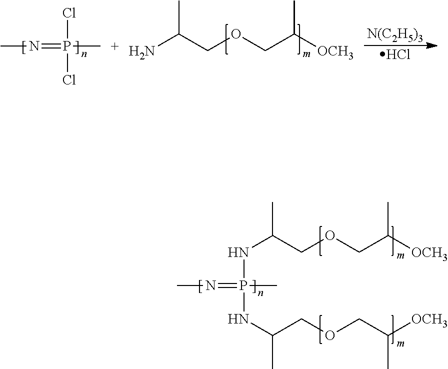

In a representative procedure, 4.69 g of [NPCI₂]ₙ were dissolved in 200 nil of anhydrous TI-IF to form a polymer solution. Then, 11.3 ml of triethyl amine (TEA) and 50 ml of propylene oxide oligomer were then added to the polymer solution. The resulting reaction mixture was stirred for 24 h at room temperature. The solvent was then removed under vacuum yielding a highly viscous yellowish polymer solution which was dialyzed against water for 5 days. Removal of water after dialysis yielded a slightly yellowish, highly viscous polymer.

The substituted polyphosphazene, 15% by weight of lithium hexafluorophosphate (LiPF₆), and 0.5% by weight of benzophenone as photoinitiator were then dispersed/dissolved in a 50/50 solvent mixture of fluoroethylene carbonate (FEC) and vinylene carbonate (VC) to form a solution. Nanoparticles of Al₂O₃ and SiO₂ were separately added as an inorganic filler. The slurry was coated on a surface of Cu foil to form a separator layer, which was exposed to UV light for 20 minutes to induce crosslinking reaction.

The anode, separator, and cathode layers were then stacked together and encased by a protective housing to make a battery cell.

For electrochemical testing, the working electrodes (cathode layers) were prepared by mixing 85 wt. % LiV₂O₅ or 88% of graphene-embraced LiV₂O₅ particles, 5-8 wt. % CNTs, and 7 wt. % polyvinylidene fluoride (PVDF) binder dissolved in N-methyl-2-pyrrolidinoe (NMP) to form a slurry of 5 wt. % total solid content. After coating the slurries on Al foil, the electrodes were dried at 120° C. in vacuum for 2 h to remove the solvent before pressing. Then, the electrodes were cut into a disk (ϕ=12 mm) and dried at 100° C. for 24 h in vacuum.

Electrochemical measurements were conducted on cells that are initially lithium metal-free and cells that contain a lithium foil. In the former cells (anode-less cells), a Cu foil coated with a polymer composite separator, and a cathode layer were combined to form a cell, which was injected with an electrolyte solution containing 1 M LiPF₆ dissolved in a mixture of ethylene carbonate (EC) and diethyl carbonate (DEC) (EC-DEC, 1:1 v/v). The cell assembly was performed in an argon-filled glove-box. For comparison purposes, cells with the conventional Celgard 2400 membrane (porous PE-PP film) as a separator. The CV measurements were carried out using a CH-6 electrochemical workstation at a scanning rate of 1-100 mV/s. The electrochemical performance of the cell featuring the polymer composite separator and that containing a conventional separator were evaluated by galvanostatic charge/discharge cycling at a current density of 50 mA/g using an Arbin electrochemical workstation.

The specific intercalation capacity curves of two lithium cells each having a cathode containing LiV₂O₅ particles (one cell having a flame retardant polymer-based separator and the other a conventional separator) were obtained and compared. As the number of cycles increases, the specific capacity of the conventional cells drops at a very fast rate. In contrast, the presently disclosed cross-linked polymer composite-based protection layer provides the battery cell with a significantly more stable and high specific capacity for a large number of cycles. These data have demonstrated the surprising and superior performance of the presently disclosed cross-linked polymer composite separator approach.

### EXAMPLE 11: Polymer Composite Separators from Vinylphosphonic Acid (VPA) and Triethylene Glycol Dimethacrylate (TEGDA) or Acrylic Acid (AA)

The free radical polymerization of acrylic acid (AA) with vinylphosphonic acid (VPA) can be catalyzed with benzoyl peroxide as the initiator. In a vessel provided with a reflux condenser, 150 parts vinylphosphonic acid were dissolved in 150 parts isopropanol and heated for 5 hours at 90° C. together with 0.75 parts benzoyl peroxide and 20 parts of lithium bis(oxalato)borate (LiBOB). A very viscous clear solution of polyvinylphosphonic acid was obtained. On a separate basis, a. similar reactive mixture was added with a desirable amount (e.g., 10-50 parts) of AA or TEGDA as a co-monomer. The solutions were separately cast onto a glass surface and cured in a vacuum oven at 90° C. for 5 hours to obtain polymer layers.

In a separate experiment, vinylphosphonic acid was heated to >45° C. (melting point of VPA=36° C.), which was added with benzoyl peroxide, LiBOB. Particles of an inorganic solid electrolyte (LLZT) was added into the reactive mass. After rigorous stirring, the resulting paste was cast onto a glass surface and cured at 90° C. for 5 hours to form a layer. A polymer composite separator layer was then laminated between a Cu foil and a cathode active material layer (containing a NCM-532) for use in an anode-less lithium battery (initially the cell being lithium-free). Another polymer composite layer was disposed between a Cu foil-supported lithium metal foil and a sulfur cathode in a lithium-sulfur cell.

### EXAMPLE 12: Polymer Composite Separator Layer from Free Radical Polymerization of Diisopropyl-p-Vinylbenzyl Phosphonate and 1-Vinylimidazole

Copolymers of diisopropyl-p-vinylbenzyl phosphonate (DIPVBP) and 1-vinylimidazole (1VI) were prepared by free radical polymerization. First, Diisopropyl-p-vinylbenzyl phosphonate was synthesized by taking the following procedure: Potassium tert-butoxide (8.16 g, 72.7 mmol) in dry THF (40 mL) was added dropwise into stirred solution of diisopropyl phosphate (14.19 g, 85.4 mmol) and p-vinylbenzyl chloride (10.72 g, 70.25 mmol) in THF within 2 h. The reaction was maintained at room temperature throughout by occasional cooling with an ice bath. The mixture was under stirring for another hour at room temperature and then filtered, diluted with diethyl ether (200 mL), and washed with water (100 mL) three times. The organic component was then dried over sodium sulfate. The raw product was then purified by flash column chromatography on silica. Residual vinylbenzyl chloride was eluted with toluene, and subsequently the product was washed off with ethyl acetate to yield colorless oil.

Synthesis of Poly(diisopropyl-p-vinylbenzyl phosphonate-co-1-vinylimidazole) was conducted with various feed ratios of 1VI and DIPVBP in toluene solution at 70° C. with AIBN as initiator. Specifically, the copolymers (with feed ratios of monomers from 1/9 to 9/1) were synthesized by dissolving 1VI and DIPVBP in toluene. Approximately 1% by weight of AIBN (relative to the total monomer weight) in toluene was added into the solution. The reaction mixture was stirred under a nitrogen atmosphere at 70° C. for 2 hours to obtain the copolymer, which was cast on a glass surface. The polymerization was illustrated in Reaction 13 presented in an earlier section.

The homopolymer of DIPVBP was synthesized by free radical polymerization in toluene under similar conditions to the copolymers.

In an additional experiment, poly(diisopropyl-p-vinylbenzyl phosphonate-co-1-vinylimidazole) prepared above was dissolved in ethanol and reacted with excess HCl aqueous solution (10 mol/L) at 100° C. for 24 h, and the corresponding poly(vinylbenzylphosphonic acid-co-1-vinylimidazole) was obtained after purification. This co-polymer was cast on a glass surface to obtain a layer for tensile testing and lithium ion conductivity measurement.

The room temperature lithium-ion conductivity values of the poly(diisopropyl-p-vinylbenzyl phosphonate) homo-polymer, the poly(diisopropyl-p-vinylbenzyl phosphonate-co-1-vinylimidazole) copolymer, and the poly(vinylbenzylphosphonic acid-co-1-vinylimidazole) copolymer (each containing approximately 5% by weight lithium salt) were approximately 2.5×10⁻⁵ S/cm, 7.4×10⁻⁴ S/cm, and 5.6×10⁻³ S/cm, respectively. The polymers are flame resistant and relatively safe, being capable of stopping lithium dendrite formation or penetration particularly when reinforced with particles of an inorganic solid electrolyte (e.g., LIPON-type).

Two types of battery cells were studied in this example: a lithium/NCM-811 cell (initially the cell being lithium-free at the anode side) and a lithium/NCA cathode (initially lithium-free at the anode). For both types of battery cells, the polymer composite layers serves as a dual role of an anode protecting layer and a separator. The polymer composite layer is in physical contact with either an anode current collector surface or an anode active material layer.

### EXAMPLE 13: Polymer Composite Separator Layers Based on Homo-Polymers and Copolymers from Dimethyl(Methacryloyloxy)-Methyl Phosphonate (MAPC1)

A phosphonated methacrylate, namely dimethyhmethacryloyloxy)-methyl phosphonate (MAPC1), was synthesized using paraformaldehyde and potassium carbonate. This began with the synthesis of Dimethyl-a-Hydroxymethylphosphonate by following the procedure below: Ten grams (0.09 mol) of dimethyl hydrogenophosphonate, 2.73 g (0.09 mol) of paraformaldehyde, 30 mL of methanol, and 0.62 g of anhydrous K₂CO₃ were introduced in a two-necked flask equipped with a condenser. The solution was vigorously stirred under methanol refluxing for 2 h. Dimethyl-a-hydroxymethylphosphonate was obtained under high vacuum with 98% yield.

For the synthesis of Dimethyl(methacrylox methyl Phosphonate (MAPC1), ten grams (0.071 mol) of dimethyl-a-hydroxymethylphosphonate, 6.15 g (0.071 mol) of methacrylic acid, and 30 mL of chloroform were introduced in a two-necked flask equipped with a condenser. Temperature was dropped until 0° C. and, after degasing, 14.73 g (0.0071 mol) of dicyclohexylcarbodiimide (DCCI), 0.872 g (0.0071 mol) of N,N-dimethyl-4-aminopyridine (DMAP) were added in a dropwise manner. The solution was vigorously stirred at room temperature for 2 h. After filtration, MAPC1 is obtained by distillation under high vacuum (100° C. with 2×10⁻² mmHg) with 90% yield.

The synthesis of Methyhmethacryloxy)methyl Phosphonic Hemi-Acid MAPC1(OH) was conducted in the following manner: Four grams (0.019 mol) of MAPC1, 2 g (0.019 mol) of NaBr, and 20 mL of methylethylketone were introduced in a two-necked flask equipped with a condenser and with a magnetic stirrer. The reaction mixture was heated under reflux with stirring for 1:3 h and at room temperature for 4 h. The sodium salt was precipitated, filtered, and washed several times with acetone to remove residues. The white powder was dried under high vacuum for 2 h (88% yield). The sail was solubilized in methanol and passed through a column filled with sulfonic acid resin. The column was washed with methanol until reaching neutral pH, and the final MAPC1(OH) was obtained with 97% yield.

Homo polymerization and copolymerization of MAPC1 and MAPC1(OH) with MMA were conducted in a three-necked flask equipped with a condenser, a septum cap (to be able to take aliquots), and a magnetic stirrer in acetonitrile refluxing and with AIBN as initiator. Radical polymerization of MAPC1 was performed at 80° C. in acetonitrile, initiated with AWN (1 mol %) for 2 h, and the MAPC1 conversion was monitored over time. Radical copolymerizations of both MAPC1 and MAPC1(OH) with MMA were then carried out in acetonitrile at 80° C. initiated by AIBN (1 mol %). Polymerizing solutions (along with inorganic NASICON particles) were cast onto Cu foil surfaces and glass surfaces to form layers prior to completion of the polymerization reactions.

Three types of battery cells were studied in this example: a lithium/NCM-811 cell (initially the cell being lithium-free), a Si/NCM-811 cell, and a lithium-sulfur cell.

### EXAMPLE 14: Diethyl Vinylphosphonate and Diisopropyl Vinylphosphonate Polymers for Separator Preparation

Both diethyl vinylphosphonate and diisopropyl vinylphosphonate were polymerized by a peroxide initiator (di-tert-butyl peroxide), along with LiBF₄, to clear, light-yellow polymers of low molecular weight. In a typical procedure, either diethyl vinylphosphonate or diisopropyl vinylphosphonate (being a liquid at room temperature) is added with di-tert-butyl peroxide (0.5-2% by weight) and LiBF₄ (5-10% by weight) to form a reactive solution. LLZO nano particles were separately dispersed into the reactive solution. The resulting suspension was heated to 45° C., allowing bulk polymerization to proceed for 2-12 hours. Subsequently, the suspension was cast to form polymer composite layers.

Additionally, layers of diethyl vinylphosphonate and diisopropyl vinylphosphonate polymer electrolytes were cast on glass surfaces and polymerized under comparable conditions. The lithium ion conductivity of these materials was measured. The lithium ion conductivity of diethyl vinylphosphonate derived polymers was found to be in the range from 5.4×10⁻⁵ S/cm-7.3×10⁻⁴ S/cm and that of diisopropyl vinylphosphonate polymers in the range from 6.6×10⁻⁵ S/cm-8.4×10⁻⁴ S/cm. Both are highly flame resistant.

Electrochemical measurements (CV curves) were carried out in an electrochemical workstation at a scanning rate of 1-100 mV/s. The electrochemical performance of the cells was evaluated by galvanostatic charge/discharge cycling at a current density of 50-500 mA/g using an Arbin electrochemical workstation. Testing results indicate that the cells containing a protective layer perform very well in terms of cycling stability and the energy storage capacity and yet these cells are flame resistant and relatively safe.

### EXAMPLE 15: Curing of Cyclic Esters of Mixtures of Phosphoric Acids and LLZO Particles (60%-90% by Weight)

As selected examples of polymers from phosphates, five-membered cyclic esters of phosphoric acid of the general formula, —CH₂CH(R)OP(O)—(OR′)O—, were polymerized to solid, soluble polymers of high molecular weight by using n-C₄H₉Li, (C₅H₅)₂Mg, or (i-C₄H₉)₃Al as initiators. The resulting polymers have a repeating unit as follows:

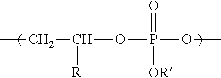

where R is H, with R′═CH₃, C₂H₅, n-C₃H₇, i-C₃H₇; n-C₄H₉, CCl₃CH₂ or C₆H₅, or R is CH₂Cl and R′ is C₂H₅. The polymers typically have Mₙ=10⁴−10⁵.

In a representative procedure, initiators n-C₄H₉Li (0.5% by weight) and 5% lithium bis(oxalato)borate (LiBOB) as a lithium salt were mixed with 2-alkoxy-2-oxo-1,3,2-dioxaphospholan (R′═H in the following chemical formula):

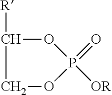

Temperature or a second solvent may be used to adjust the viscosity of the reactant mixture, where necessary. The solution was cast as thin films 1-10 μm, which were allowed to undergo the anionic polymerization at room temperature (or lower) overnight to form a polymer solid. The room temperature lithium ion conductivities of this series of solid polymers are in the range from 2.5×10−5 S/cm-1.6×10⁻³ S/cm.

Separately, the reacting mass was cast onto a glass surface to form several thicker films (20-110 μm thick) which were cured to obtain polymers. Tensile testing was conducted on these films. This series of polymers can be elastically stretched up to approximately 68%.

In several samples, a garnet-type solid electrolyte (Li₇La₃Zr₂O₁₂ (LLZO) powder) was added into the protective layers.

In conclusion, the thermally stable polymer composite-based separator strategy is surprisingly effective in alleviating the problems of lithium metal dendrite formation and lithium metal-electrolyte reactions that otherwise lead to rapid capacity decay and potentially internal shorting and explosion of the lithium secondary batteries. The phosphorus-containing polymer matrix or binder is also thermally resistant. This type of polymer is normally elastic in nature. The elastic polymer composite is capable of expanding or shrinking congruently or conformably with the anode layer. This capability helps to maintain a good contact between the current collector (or the deposited lithium film during the charging procedure) and the separator, enabling uniform re-deposition of lithium ions without interruption.

1. A lithium secondary battery comprising a cathode, an anode, and a thermally stable polymer composite separator disposed between said cathode and said anode, wherein said composite separator comprises a thermally stable polymer, comprising a phosphorous-containing polymer, and from 30% to 99% by weight of particles of an inorganic material and said particles are dispersed in or bonded by said thermally stable polymer, wherein said composite separator has a thickness from 50 nm to 100 μm and a lithium ion conductivity from 10⁻⁸ S/cm to 5×10⁻² S/cm at room temperature.

2. The lithium secondary battery of claim 1, wherein the phosphorous-containing polymer is selected from polyphosphazene, polyphosphate, polyphosphonate, polyphosphinate, polyphosphine, polyphosphine oxide, poly(phosphonic acid), polymerized phosphorous acid, polymerized phosphite, poly(phosphoric acid), or a combination thereof.

3. The lithium secondary battery of claim 1, wherein the battery is a lithium metal battery and the anode has an anode current collector but initially the anode has no lithium or lithium alloy as an anode active material supported by said anode current collector when the battery is made and prior to a charge or discharge operation of the battery.

4. The lithium secondary battery of claim 1, wherein the battery is a lithium metal battery and the anode has an anode current collector and an amount of lithium or lithium alloy as an anode active material supported by said anode current collector.

5. The lithium secondary battery of claim 1, wherein the battery is a lithium-ion battery and the anode has an anode current collector and a layer of an anode active material supported by said anode current collector, wherein the anode active materials is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles (g) prelithiated versions thereof; and (h) combinations thereof.

6. The lithium secondary battery of claim 1, wherein said inorganic material comprises particles of an inorganic solid electrolyte material selected from an oxide type, sulfide type, hydride type, halide type, borate type, phosphate type, lithium phosphorus oxynitride (LiPON), Garnet-type, lithium superionic conductor (LISICON) type, sodium superionic conductor (NASICON) type, or a combination thereof.

7. The lithium secondary battery of claim 1, wherein said inorganic material particles comprise a material selected from a transition metal oxide, aluminum oxide, silicon dioxide, transition metal sulfide, transition metal selenide, alkylated ceramic particles, metal phosphate, metal carbonate, or a combination thereof.

8. The lithium secondary battery of claim 1, wherein the thermally stable polymer further comprises from 0.1% to 30% by weight of a lithium ion-conducting additive, which is different from the inorganic solid electrolyte particles in composition or structure.

9. The lithium secondary battery of claim 8, wherein said lithium ion-conducting additive comprises a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

10. The lithium secondary battery of claim 8, wherein said lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0≤x≤1, 1≤y≤4.

11. The lithium secondary battery of claim 1, wherein the thermally stable polymer forms a mixture, blend, copolymer, or interpenetrating network with a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

12. The lithium secondary battery of claim 1, wherein said battery further comprises, in addition to the solid electrolyte in the separator, a working electrolyte in ionic contact with an anode active material and/or a cathode active material wherein said working electrolyte is selected from an organic liquid electrolyte, ionic liquid electrolyte, polymer gel electrolyte, polymer solid electrolyte, solid-state inorganic electrolyte, quasi-solid electrolyte having a lithium salt dissolved in an organic or ionic liquid with a lithium salt concentration higher than 2.0 M, or a combination thereof.

13. The lithium secondary battery of claim 1, wherein said cathode comprises a cathode active material selected from an inorganic material, an organic material, a polymeric material, or a combination thereof.

14. The lithium secondary battery of claim 13, wherein said inorganic material, as a cathode active material, is selected from a metal oxide, metal phosphate, metal silicide, metal selenide, transition metal sulfide, metal fluoride, metal chloride, or a combination thereof.

15. The lithium secondary battery of claim 13, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

16. The lithium secondary battery of claim 13, wherein said inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

17. The lithium secondary battery of claim 14, wherein said metal oxide contains a vanadium oxide selected from the group consisting of LiₓVO₂, LiₓV₂O₅, LiₓV₃O₈, LiₓV₃O₇, LiₓV₄O₉, LiₓV₆O₁₃, their doped versions, their derivatives, and combinations thereof, wherein 0.1<x<5.

18. The lithium secondary battery of claim 14, wherein said metal oxide or metal phosphate is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

19. A polymer composite separator for use in a lithium battery, said separator comprising a thermally stable polymer, comprising a phosphorous-containing polymer, and from 30% to 99% by weight of particles of an inorganic material wherein said particles are dispersed in or bonded by said thermally stable polymer and wherein said composite separator has a thickness from 50 nm to 100 μm and a lithium ion conductivity from 10⁻⁸ S/cm to 5×10⁻² S/cm at room temperature.

20.-37. (canceled)

38. A process for manufacturing the polymer composite separator of claim 1, the process comprising (A) dispersing particles of the inorganic solid material in a liquid reactive mass of a polymer precursor to the thermally stable polymer to form a slurry; (B) dispensing and depositing a layer of said liquid reactive mass onto a solid substrate surface; and (C) polymerizing and/or curing said reactive mass to form said layer of polymer composite separator.

39. The process of claim 38, wherein said solid substrate is an anode current collector, an anode active material layer, or a cathode active material layer.

40. The process of claim 38, which is a roll-to-roll process wherein said step (B) comprises (i) continuously feeding a layer of said solid substrate from a feeder roller to a dispensing zone where said reactive mass is dispensed and deposited onto said solid substrate to form a continuous layer of said reactive mass; (ii) moving said layer of the reactive mass into a reacting zone where the reactive mass is exposed to heat, ultraviolet light, or high-energy radiation to polymerize and/or cure said reactive mass to form a continuous layer of polymer composite; and (iii) collecting said polymer composite on a winding roller.

41. The process of claim 40, further comprising cutting and trimming said layer of polymer composite into one or multiple pieces of polymer composite separators.

42. The process of claim 40, further comprising a step of combining an anode, said polymer composite separator, an electrolyte, and a cathode electrode to form a lithium battery.
